(19) United States
(12) Patent Application Publication
(10) Pub. No.: US 2025/0038934 A1
(43) Pub. Date: Jan. 30, 2025

(54) REFERENCE SIGNAL COMMUNICATION IN THE PRESENCE OF UNIFIED TRANSMISSION CONFIGURATION INDICATOR STATES

(71) Applicant: QUALCOMM INCORPORATED, San Diego, CA (US)

(72) Inventors: Mostafa Khoshnevisan, San Diego, CA (US); Yan Zhou, San Diego, CA (US); Fang Yuan, Beijing (CN); Tao Luo, San Diego, CA (US); Xiaoxia Zhang, San Diego, CA (US)

(21) Appl. No.: 18/715,645

(22) PCT Filed: Jan. 19, 2022
(86) PCT No.: PCT/CN2022/072769

§ 371 Date: May 31, 2024

(51) Int. Cl. H04L 5/00

(52) U.S. Cl. CPC H04L 5/0092; H04L 5/005

(57) ABSTRACT

Methods, systems, and devices for wireless communications are described. Generally, a user equipment (UE) that has been configured with two transmission configuration indicator (TCI) states may determine which TCI state of the two the UE is to apply to reference signal resources. A base station may configure a set of TCI states and activate a subset of the TCI states, and may indicate one or two of the activated TCI states for communication on a channel for a time period. The base station may transmit an indication of which of the two TCI states the UE is to apply for reference signal resources. The UE may determine which of the two TCI states to use for reference signal resources based on one or more rules, which may be based on identifiers (e.g., based on comparing identifiers for reference signal resources, reference signal resource sets, or groups of reference signal resources).

### FIELD OF TECHNOLOGY

The present Application is a 371 national stage filing of International PCT Application No. PCT/CN2022/072769 by Khoshnevisan et al. entitled “REFERENCE SIGNAL COMMUNICATION IN THE PRESENCE OF UNIFIED TRANSMISSION CONFIGURATION INDICATOR STATES,” filed Jan. 19, 2022, which is assigned to the assignee hereof, and which is expressly incorporated by reference in its entirety herein.

### FIELD OF TECHNOLOGY

The following relates to wireless communications, including reference signal communication in the presence of unified transmission configuration indicator states.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE). In some systems, UEs and base station may use one or more beam configurations for communications. Such beam configurations may be indicated by a transmission configuration indicator (TCI) state, where a UE and base station may use one or more TCI states for uplink communications, downlink communications, or both.

### SUMMARY

The described techniques relate to improved methods, systems, devices, and apparatuses that support reference signal communication in the presence of unified transmission configuration indicator states. Generally, a user equipment (UE) that has been configured with two transmission configuration indicator (TCI) states may determine which TCI state of the two (e.g., if any) the UE is to apply to reference signal resources. The UE may be configured with a set of TCI states. A base station may activate a subset of the TCI states, and may indicate one or two of the activated TCI states for communication on a channel for a time period (e.g., until otherwise indicated or changed). The base station may transmit, to the UE, an indication of which of the two TCI states the UE is to apply for reference signal resources (e.g., channel state information reference signal (CSI-RS) resources or sounding reference signal (SRS) resources). The indication may be included in a radio resource control (RRC) message, a media access control (MAC) control element (CE) message, or a downlink control information (DCI) message. In some examples, the UE may determine which of the two TCI states to use for reference signal resources based on one or more rules. The rules may be based on identifiers (e.g., based on comparing identifiers for reference signal resources, reference signal resource sets, or groups of reference signal resources), or may be based on one or more cases or conditions.

A method for wireless communications at a UE is described. The method may include receiving, from a network entity, first control signaling identifying two or more TCI states that are to be applied to communications of one or more channels subsequent to a determined time, receiving, from the network entity, second control signaling including an indication of which TCI state of a pair of TCI states the UE is to apply for communicating reference signals, receiving, from the network entity, control information associated with one or more resource allocations for communications after the determined time according to two TCI states of the two or more TCI states, the one or more resource allocations associated with one or more reference signal resources, and communicating according to a first TCI state of the two TCI states via the one or more reference signal resources based on the indication.

An apparatus for wireless communications at a UE is described. The apparatus may include a processor, memory coupled with the processor, and instructions stored in the memory. The instructions may be executable by the processor to cause the apparatus to receive, from a network entity, first control signaling identifying two or more TCI states that are to be applied to communications of one or more channels subsequent to a determined time, receive, from the network entity, second control signaling including an indication of which TCI state of a pair of TCI states the UE is to apply for communicating reference signals, receive, from the network entity, control information associated with one or more resource allocations for communications after the determined time according to two TCI states of the two or more TCI states, the one or more resource allocations associated with one or more reference signal resources, and communicate according to a first TCI state of the two TCI states via the one or more reference signal resources based on the indication.

Another apparatus for wireless communications at a UE is described. The apparatus may include means for receiving, from a network entity, first control signaling identifying two or more TCI states that are to be applied to communications of one or more channels subsequent to a determined time, means for receiving, from the network entity, second control signaling including an indication of which TCI state of a pair of TCI states the UE is to apply for communicating reference signals, means for receiving, from the network entity, control information associated with one or more resource allocations for communications after the determined time according to two TCI states of the two or more TCI states, the one or more resource allocations associated with one or more reference signal resources, and means for communicating according to a first TCI state of the two TCI states via the one or more reference signal resources based on the indication.

A non-transitory computer-readable medium storing code for wireless communications at a UE is described. The code may include instructions executable by a processor to receive, from a network entity, first control signaling identifying two or more TCI states that are to be applied to communications of one or more channels subsequent to a determined time, receive, from the network entity, second control signaling including an indication of which TCI state of a pair of TCI states the UE is to apply for communicating reference signals, receive, from the network entity, control information associated with one or more resource allocations for communications after the determined time according to two TCI states of the two or more TCI states, the one or more resource allocations associated with one or more reference signal resources, and communicate according to a first TCI state of the two TCI states via the one or more reference signal resources based on the indication.

In some examples of the method, apparatuses, and non-transitory computer-readable medium described herein, the two or more TCI states provide for multi-transmission reception point communication with two or more transmission reception points associated with the network entity.

In some examples of the method, apparatuses, and non-transitory computer-readable medium described herein, receiving the second control signaling including the indication may include operations, features, means, or instructions for receiving a radio resource control message including the indication, where the indication may be associated with a component carrier or a bandwidth part corresponding to the one or more resource allocations.

In some examples of the method, apparatuses, and non-transitory computer-readable medium described herein, receiving the second control signaling including the indication may include operations, features, means, or instructions for receiving a radio resource control message including the indication, where the indication may be associated with a reference signal resource set or a single reference signal resource.

In some examples of the method, apparatuses, and non-transitory computer-readable medium described herein, receiving the second control signaling including the indication may include operations, features, means, or instructions for receiving a MAC-CE including the indication, where the MAC-CE activates the one or more reference signal resources from a set of multiple previously configured reference signal resource sets.

In some examples of the method, apparatuses, and non-transitory computer-readable medium described herein, receiving the second control signaling including the indication may include operations, features, means, or instructions for receiving downlink control information (DCI) including the indication, the DCI triggering an aperiodic reference signal resource set including the one or more reference signal resources.

In some examples of the method, apparatuses, and non-transitory computer-readable medium described herein, communicating via the one or more reference signal resources may include operations, features, means, or instructions for receiving one or more channel state information reference signals via the one or more reference signal resources, where the two TCI states include a pair of downlink TCI states or a pair of joint TCI states.

In some examples of the method, apparatuses, and non-transitory computer-readable medium described herein, communicating via the one or more reference signal resources may include operations, features, means, or instructions for transmitting one or more sounding reference signals via the one or more reference signal resources, where the two TCI states include a pair of uplink TCI states or a pair of joint TCI states.

In some examples of the method, apparatuses, and non-transitory computer-readable medium described herein, the indication may include operations, features, means, or instructions for an instruction to apply a TCI state of a pair of TCI states that may be associated with a lowest index value.

In some examples of the method, apparatuses, and non-transitory computer-readable medium described herein, the control information may be a scheduling DCI that indicates allocated resources for communications, or may be an activation DCI that activates communication using previously configured resources.

In some examples of the method, apparatuses, and non-transitory computer-readable medium described herein, the two or more TCI states may be associated with multi-transmission reception point communications with two or more transmission reception points according to a time division multiplexing communications scheme, a frequency division multiplexing communications scheme, a spatial division multiplexing communications scheme, or a single frequency network communications scheme.

In some examples of the method, apparatuses, and non-transitory computer-readable medium described herein, the one or more channels include a downlink shared channel, uplink shared channel, uplink control channel, or any combinations thereof, and where and the first control signaling includes one or more of downlink control information having a first format with a TCI state field, or a medium access control (MAC) control element (CE) that indicates a single TCI codepoint that may be mapped to the two or more TCI states.

A method for wireless communications at a UE is described. The method may include receiving, from a network entity, first control signaling identifying two or more TCI states that are to be applied to communications of one or more channels subsequent to a determined time, receiving, from the network entity, control information associated with one or more resource allocations for communications after the determined time according to a first TCI state and a second TCI state of the two or more TCI states, the one or more resource allocations associated with a first set of one or more reference signal resources and a second set of one or more reference signal resources, and communicating via the first set of one or more reference signal resources according to the first TCI state based on a first identifier associated with the first set of one or more reference signal resources and via the second set of one or more reference signal resources according to the second TCI state based on a second identifier associated with the second set of one or more reference signal resources.

An apparatus for wireless communications at a UE is described. The apparatus may include a processor, memory coupled with the processor, and instructions stored in the memory. The instructions may be executable by the processor to cause the apparatus to receive, from a network entity, first control signaling identifying two or more TCI states that are to be applied to communications of one or more channels subsequent to a determined time, receive, from the network entity, control information associated with one or more resource allocations for communications after the determined time according to a first TCI state and a second TCI state of the two or more TCI states, the one or more resource allocations associated with a first set of one or more reference signal resources and a second set of one or more reference signal resources, and communicate via the first set of one or more reference signal resources according to the first TCI state based on a first identifier associated with the first set of one or more reference signal resources and via the second set of one or more reference signal resources according to the second TCI state based on a second identifier associated with the second set of one or more reference signal resources.

Another apparatus for wireless communications at a UE is described. The apparatus may include means for receiving, from a network entity, first control signaling identifying two or more TCI states that are to be applied to communications of one or more channels subsequent to a determined time, means for receiving, from the network entity, control information associated with one or more resource allocations for communications after the determined time according to a first TCI state and a second TCI state of the two or more TCI states, the one or more resource allocations associated with a first set of one or more reference signal resources and a second set of one or more reference signal resources, and means for communicating via the first set of one or more reference signal resources according to the first TCI state based on a first identifier associated with the first set of one or more reference signal resources and via the second set of one or more reference signal resources according to the second TCI state based on a second identifier associated with the second set of one or more reference signal resources.

A non-transitory computer-readable medium storing code for wireless communications at a UE is described. The code may include instructions executable by a processor to receive, from a network entity, first control signaling identifying two or more TCI states that are to be applied to communications of one or more channels subsequent to a determined time, receive, from the network entity, control information associated with one or more resource allocations for communications after the determined time according to a first TCI state and a second TCI state of the two or more TCI states, the one or more resource allocations associated with a first set of one or more reference signal resources and a second set of one or more reference signal resources, and communicate via the first set of one or more reference signal resources according to the first TCI state based on a first identifier associated with the first set of one or more reference signal resources and via the second set of one or more reference signal resources according to the second TCI state based on a second identifier associated with the second set of one or more reference signal resources.

In some examples of the method, apparatuses, and non-transitory computer-readable medium described herein, the two or more TCI states provide for multi-transmission reception point communications with two or more transmission reception points associated with the network entity.

Some examples of the method, apparatuses, and non-transitory computer-readable medium described herein may further include operations, features, means, or instructions for receiving, from the network entity, second control signaling configuring the first set of one or more reference signal resources and the second set of one or more reference signal resources, where the communicating may be based on applying the first TCI state to the first set of one or more reference signal resources and applying the second TCI state to the second set of one or more reference signal resources.

In some examples of the method, apparatuses, and non-transitory computer-readable medium described herein, the first set of one or more reference signal resources includes a first group of reference signal resources within a reference signal resource set and the second set of one or more reference signal resources includes a second group of reference signal resources within the reference signal resource set, the first identifier may be associated with the first group of reference signal resources, and the second identifier may be associated with the second group of reference signal resources.

In some examples of the method, apparatuses, and non-transitory computer-readable medium described herein, the first set of one or more reference signal resources includes a first reference signal resource set and the second set of one or more reference signal resources includes a second reference signal resource set, the first identifier may be associated with the first reference signal resource set, and the second identifier may be associated with the second reference signal resource set.

Some examples of the method, apparatuses, and non-transitory computer-readable medium described herein may further include operations, features, means, or instructions for receiving, from the network entity, a radio resource control message configuring the UE to share a same beam indication, where applying the first TCI state to the first set of one or more reference signal resources and applying the second TCI state to the second set of one or more reference signal resources may be based on receiving the radio resource control message.

In some examples of the method, apparatuses, and non-transitory computer-readable medium described herein, the first set of one or more reference signal resources and the second set of one or more reference signal resources may be aperiodic reference signal resources.

In some examples of the method, apparatuses, and non-transitory computer-readable medium described herein, the communicating may be based on a number of reference signal resources in the first set of one or more reference signal resources, the second set of one or more reference signal resources, or both.

Some examples of the method, apparatuses, and non-transitory computer-readable medium described herein may further include operations, features, means, or instructions for applying the first TCI state to the first set of one or more reference signal resources and applying the second TCI state to the second set of one or more reference signal resources may be based on the first identifier having a lower value than the second identifier.

In some examples of the method, apparatuses, and non-transitory computer-readable medium described herein, receiving the second signaling configuring the first set of one or more reference signal resources and the second set of one or more reference signal resources may include operations, features, means, or instructions for receiving a radio resource control parameter configuring the first set of one or more reference signal resources and the second set of one or more reference signal resources associated with repetition, tracking reference signal (TRS) reception, beam management, antenna switching, codebook-based uplink transmission, non-codebook based uplink transmission, or a combination thereof.

In some examples of the method, apparatuses, and non-transitory computer-readable medium described herein, communicating via the first set of one or more reference signal resources may include operations, features, means, or instructions for receiving one or more channel state information reference signals via the first set of one or more reference signal resources and the second set of one or more reference signal resources, where the first TCI state and the second TCI state include a pair of downlink TCI states or a pair of joint transmission indicator states.

In some examples of the method, apparatuses, and non-transitory computer-readable medium described herein, communicating via the first set of one or more reference signal resources may include operations, features, means, or instructions for transmitting one or more sounding reference signals via the first set of one or more reference signal resources and the second set of one or more reference signal resources, where the first TCI state and the second TCI state include a pair of uplink TCI states or a pair of joint transmission indicator states.

In some examples of the method, apparatuses, and non-transitory computer-readable medium described herein, the one or more channels include a downlink shared channel, uplink shared channel, uplink control channel, or any combinations thereof, and where and the first control signaling includes one or more of downlink control information having a first format with a TCI state field, or a MAC-CE that indicates a single TCI codepoint that may be mapped to the two or more TCI states.

### BRIEF DESCRIPTION OF THE DRAWINGS

FIG. 1 illustrates an example of a wireless communications system that supports reference signal communication in the presence of unified transmission configuration indicator states in accordance with aspects of the present disclosure.

FIG. 2 illustrates an example of a wireless communications system that supports reference signal communication in the presence of unified transmission configuration indicator states in accordance with aspects of the present disclosure.

FIG. 3 illustrates an example of multiplexing schemes that supports reference signal communication in the presence of unified transmission configuration indicator states in accordance with aspects of the present disclosure.

FIG. 4 illustrates an example of a timeline that supports reference signal communication in the presence of unified transmission configuration indicator states in accordance with aspects of the present disclosure.

FIG. 5 illustrates an example of a timeline that supports reference signal communication in the presence of unified transmission configuration indicator states in accordance with aspects of the present disclosure.

FIG. 6 illustrates an example of a process flow that supports reference signal communication in the presence of unified transmission configuration indicator states in accordance with aspects of the present disclosure.

FIG. 7 illustrates an example of a timeline that supports reference signal communication in the presence of unified transmission configuration indicator states in accordance with aspects of the present disclosure.

FIG. 8 illustrates an example of a process flow that supports reference signal communication in the presence of unified transmission configuration indicator states in accordance with aspects of the present disclosure.

FIGS. 9 and 10 show block diagrams of devices that support reference signal communication in the presence of unified transmission configuration indicator states in accordance with aspects of the present disclosure.

FIG. 11 shows a block diagram of a communications manager that supports reference signal communication in the presence of unified transmission configuration indicator states in accordance with aspects of the present disclosure.

FIG. 12 shows a diagram of a system including a device that supports reference signal communication in the presence of unified transmission configuration indicator states in accordance with aspects of the present disclosure.

FIGS. 13 and 14 show flowcharts illustrating methods that support reference signal communication in the presence of unified transmission configuration indicator states in accordance with aspects of the present disclosure.

### DETAILED DESCRIPTION

Some wireless communications systems (e.g., 5G systems) may support different types of transmission configuration indicator (TCI) states, which may enable improved channel utilization between wireless devices. For example, a wireless communications system may support joint TCI states for both downlink signaling and uplink signaling using a unified TCI framework. In some examples, a base station may transmit a beam indication with a single TCI state (e.g., based on a unified TCI framework), which a receiving user equipment (UE) may apply to uplink or downlink channels (e.g., physical downlink control channels (PDCCHs), physical downlink shared channels (PDSCHs), physical uplink shared channels (PUSCHs), physical uplink control channels (PUCCHs), or the like). However, the UE may not be configured to apply the indicated TCI state to reference signal resources (e.g., channel state information reference signal (CSI-RS) resources or sounding reference signal (SRS) resources).

In some examples, a base station may indicate one or two TCI states for multiple transmit/receive point (mTRP) communications. In some cases, codepoints may be configured at a UE, and a particular codepoint may be indicated to the UE (e.g., in a medium access control (MAC) control element (CE)) and one or more associated TCIs may be used for communications until a subsequent different codepoint is indicated to the UE (e.g., an indication of a TCI codepoint is a “sticky” indication that is used for communications until changed). In some cases, each codepoint may include one or two TCI states, and each respective TCI state identifier in the codepoint may correspond to a TCI state type, such as uplink, downlink, or both. For example, one TCI state or multiple TCI states may be mapped to a single TCI codepoint, where the single TCI codepoint also indicates respective TCI state types for the activated TCI states. In some implementations, the base station (or other network entity) may configure two separate TCI state lists, one for downlink TCI states and one for uplink TCI states. Each codepoint may include one or multiple TCI state identifiers, and an indication of one of the two configured lists with which the TCI state identifier is associated.

In some examples, where two TCI states are applied to a channel (e.g., a physical downlink control channel (PDCCH), a physical downlink shared channel (PDSCH, a physical uplink control channel (PUCCH), a physical uplink shared channel (PUSCH), or the like) for a given time period (e.g., until changed), only one of the two TCI states may apply to reference signal resources (e.g., SRS resources or CSI-RS resources). Some wireless communications systems may not provide a mechanism for determining, by a UE configured with two TCI states (e.g., for mTRP communications), which TCI state of the two TCI states the UE is to use for reference signal resources. If the UE has no mechanism by which to determine which of the two TCI states to be applied to the channel the UE is to use for reference signal resources, the UE may fail to successful receive or transmit reference signals, which may negatively impact channel estimation, decrease channel quality, increase system latency, and decrease user experience.

In accordance with various techniques discussed herein, a UE that has been configured with two TCI states may determine which TCI state of the two (e.g., if any) the UE is to apply to reference signal resources. The UE may be configured with a set of TCI states. A base station may activate a subset of the TCI states, and may indicate one or two of the activated TCI states for communication on a channel (e.g., a PUSCH, a PUCCH, a PDSCH, a PDCCH, etc.) for a time period (e.g., until otherwise indicated or changed). The base station may transmit, to the UE, an indication of which of the two TCI states the UE is to apply for reference signal resources (e.g., CSI-RS resources or SRS resources). The indication may be included in an RRC message, a MAC-CE message, or a DCI message. In some examples, the UE may determine which of the two TCI states to use for reference signal resources based on one or more rules. The rules may be based on identifiers (e.g., based on comparing identifiers for reference signal resources, reference signal resource sets, or groups of reference signal resources), or may be based on one or more cases or conditions.

Aspects of the disclosure are initially described in the context of wireless communications systems. Aspects of the disclosure are further illustrated by and described with reference to wireless communications systems, multiplexing schemes, timelines, and process flows. Aspects of the disclosure are further illustrated by and described with reference to apparatus diagrams, system diagrams, and flowcharts that relate to reference signal communication in the presence of unified transmission configuration indicator states.

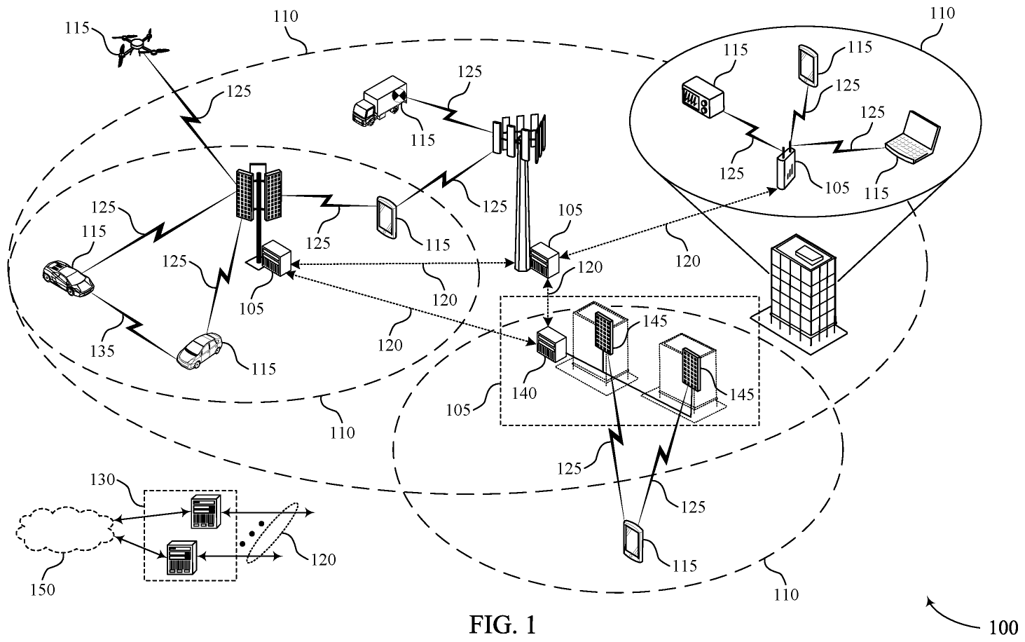

FIG. 1 illustrates an example of a wireless communications system 100 that supports reference signal communication in the presence of unified transmission configuration indicator states in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Generally, a UE 115 that has been configured with two transmission configuration indicator (TCI) states may determine which TCI state of the two (e.g., if any) the UE 115 is to apply to reference signal resources. The UE 115 may be configured with a set of TCI states. A base station 105 may activate a subset of the TCI states, and may indicate one or two of the activated TCI states for communication on a channel for a time period (e.g., until otherwise indicated or changed). The base station 105 may transmit, to the UE 115, an indication of which of the two TCI states the UE 115 is to apply for reference signal resources (e.g., channel state information reference signal (CSI-RS) resources or sounding reference signal (SRS) resources). The indication may be included in a radio resource control (RRC) message, a media access control (MAC) control element (CE) message, or a downlink control information (DCI) message. In some examples, the UE 115 may determine which of the two TCI states to use for reference signal resources based on one or more rules. The rules may be based on identifiers (e.g., based on comparing identifiers for reference signal resources, reference signal resource sets, or groups of reference signal resources), or may be based on one or more cases or conditions.

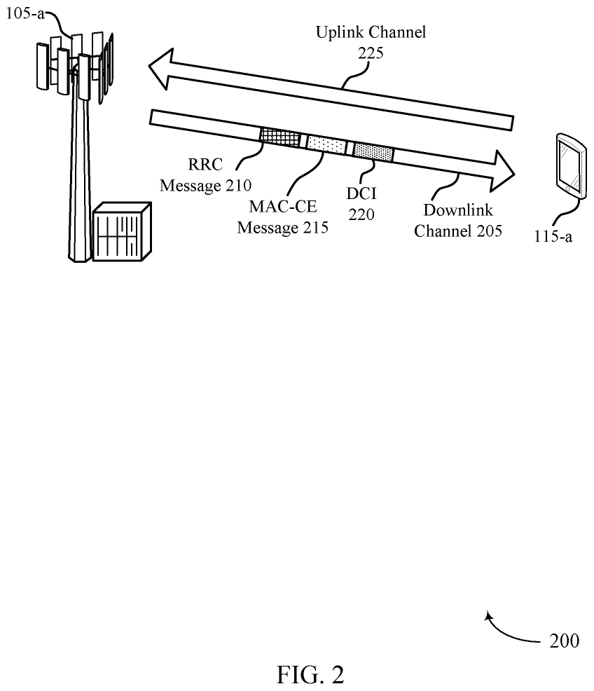

FIG. 2 illustrates an example of a wireless communications system 200 that supports transmission configuration indicator state identification in wireless communications in accordance with aspects of the present disclosure. The wireless communications system 200 may be an example of the wireless communications system 100. For example, the wireless communications system 200 may include a UE 115-a and a base station 105-a, which may be examples of the UE 115 and the base station 105 as described with reference to FIG. 1. While examples are discussed herein, any number of devices and device types may be used to accomplish implementations described in the present disclosure. As used herein, the term beam configuration may be referred to as a TCI state, and the term TCI state may be referred to as a beam configuration.

The base station 105-a and the UE 115-a may communicate via a downlink channel 205 and an uplink channel 225. In some wireless communications systems, such as 5G or NR, different types of TCI states may be used to improve channel utilization between wireless devices. For example, a wireless communications system may support joint TCI states for both downlink and uplink signaling using a unified TCI framework. In some systems, wireless communications systems may support a single TCI codepoint that is mapped to multiple TCI states, such as one downlink TCI state and one uplink TCI state. However, as discussed herein, such techniques may not clearly indicate the TCI state type of a pair of TCI states, such as joint downlink and uplink TCI states, separate uplink or downlink TCI states, common uplink or downlink TCI states, for some communications.

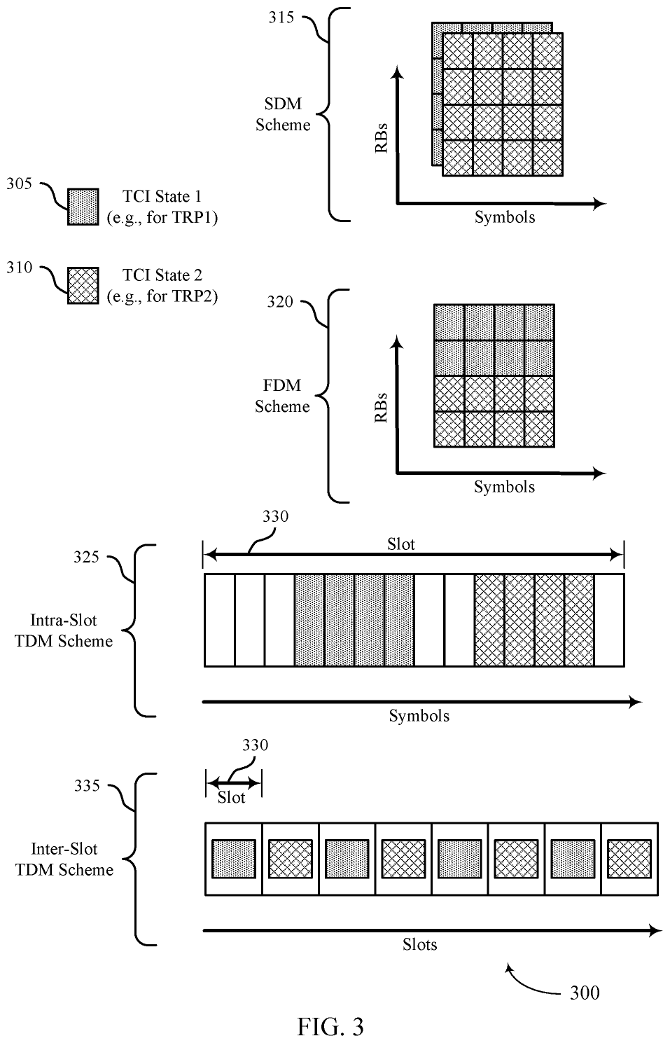

In some implementations, the UE 115-a may receive a configuration of TCI states from the base station 105-a, such as in a RRC message 210 via RRC signaling. The UE 115-a may receive a MAC-CE message 215 from the base station 105-a associated with the configuration of TCI states, where the MAC-CE message 215 may activate a subset of configured TCI states along with a mapping to TCI codepoints. In accordance with various aspects discussed herein, control information such as DCI 220 may indicate a particular TCI state codepoint, for use in communications with the base station 105-a, where the TCI codepoint indicates a particular TCI state or two or more particular TCI states from the subset of activated TCI states. In some cases, a scheduling DCI (e.g., a DCI subsequent to DCI 220, that provides a resource allocation for an uplink or downlink transmission) may indicate TCI state(s) for a communication based at least in part on one or more of a format of the control information (e.g., a DCI format), a payload field in the control information, a number of scheduled repetitions indicated in the control information, a control channel candidate or CORESET associated with the control information, a priority associated with a scheduled communication, or any combinations thereof. Various techniques discussed herein also may be applied to periodic communications (e.g., SPS communications or CG communications), where control information that activates communications (e.g., an activating DCI) may be used to indicate one or more TCI states. Various examples of TCI states, TCI state multiplexing, and signaling for one or more TCI states that are to be applied for certain communications, are discussed with reference to FIGS. 3 through 8.

FIG. 3 illustrates an example of multiplexing schemes 300 that supports reference signal communication in the presence of unified transmission configuration indicator states in accordance with aspects of the present disclosure. The multiplexing schemes 300 may implement or be implemented by one or more aspects of the wireless communications systems 100 or 200. For example, the multiplexing schemes 300 may be utilized by one or more TRPs (e.g., base stations or TRPs associated with a base station), and a UE, which may be examples of corresponding devices as described with reference to FIGS. 1 and 2.

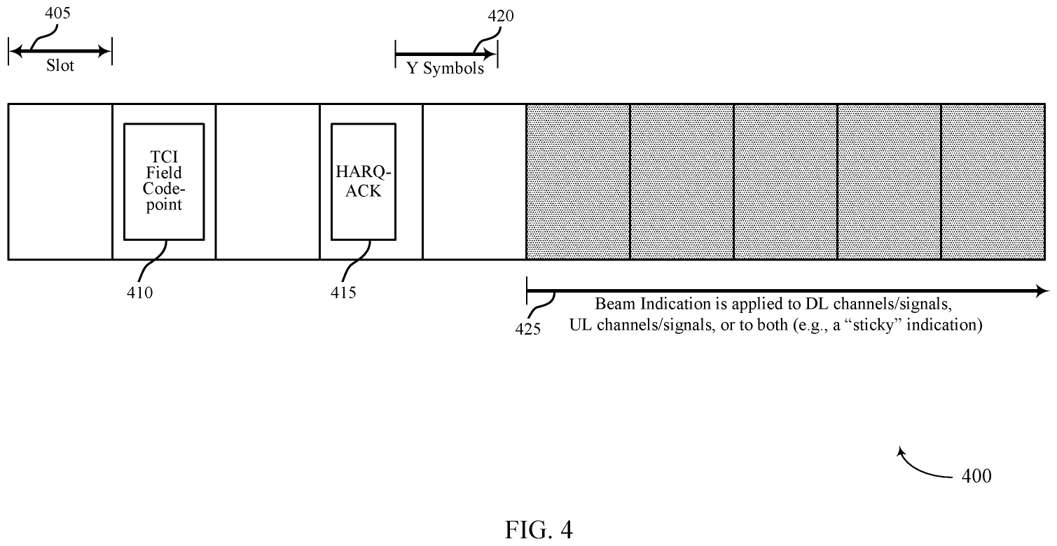

In the example of FIG. 3, a first TCI state 305 and a second TCI state 310 are illustrated. In some cases, the first TCI state 305 and the second TCI state 310 may be associated with a TCI codepoint that is provided to a UE (e.g., in a MAC-CE) and activated with an activation DCI, for use in subsequent communications with one or more TRPs. In some cases, one or more multiplexing schemes may be used. For example, a spatial division multiplexing (SDM) scheme 315 may be implemented, in which different spatial layers are associated with different TCI states. In some cases, a frequency division multiplexing (FDM) scheme 320 may be implemented, in which different frequency resources are associated with different TCI states. In other cases, time division multiplexing (TDM) may be implemented, such as an intra-slot TDM scheme 325 or an inter-slot TDM scheme 335 may have different time resources within a slot 330 or across slots 330 that are associated with different TCI states. As discussed herein, a MAC-CE may indicate TCI states based on a mapping between the one or two TCI states to TCI codepoints, and an activation DCI may activate one of the TCI codepoints. Further, a scheduling DCI may indicate one or two of the activated TCI states for a particular communication. If the indicated TCI codepoint is mapped to two TCI states, a communication with two TCI states (e.g., according to one of the multiplexing schemes of FIG. 3) is scheduled. An example of an activation DCI and TCI state application timing is discussed with reference to FIG. 4.

FIG. 4 illustrates an example of a timeline 400 that supports reference signal communication in the presence of unified transmission configuration indicator states in accordance with aspects of the present disclosure. The TCI state timing 400 may be implemented by one or more aspects of the wireless communications systems 100 or 200. For example, the TCI state timing 400 may be utilized by one or more TRPs (e.g., base stations or TRPs associated with a base station), and a UE, which may be examples of corresponding devices as described with reference to FIGS. 1 and 2.

In the example of FIG. 4, a UE and TRP may communicate in slots 405, in which one of the slots 405 may include a beam indication DCI that indicates a TCI field codepoint 410 (e.g., from two or more mapped TCI codepoints provided by a MAC-CE). As discussed herein, the TCI field codepoint 410 may be mapped to one or multiple TCI states (e.g., one or more uplink TCI states, one or more downlink TCI states, one or more joint DL/UL TCI states, or any combinations thereof). For example, one TCI field codepoint 410 may represent one or more joint downlink/uplink TCI state, which may be used for joint downlink/uplink beam indication. In another example, one TCI field codepoint 410 may represent one or more pairs with a downlink TCI state and uplink TCI state, which may be used for separate downlink/uplink beam indication. In other examples, one TCI field codepoint 410 may represent only one or more downlink TCI states, which may be used for downlink beam indication, or one TCI field codepoint 410 may represent only one or more uplink TCI states, which may be used for uplink beam indication. In some cases, if the MAC-CE indicates the mapping to only a single TCI field codepoint, it may serve as a beam indication, and a separate beam indication in a beam indication DCI may not be needed.

A UE that receives the DCI with the TCI field codepoint 410 may transmit a feedback indication, such as a HARQ-acknowledgment 415, to a base station or TRP that indicates successful receipt of the DCI. In some cases, the beam indication provided in the TCI field codepoint 410 may be applied to communications starting a predetermined time period 420 (e.g., Y symbols) after the HARQ-acknowledgment 415 (e.g., which may be an example of a determined time at which to apply the TCI state(s)). For example, the beam indication may be applied three milliseconds after HARQ-acknowledgment 415, as indicated at 425 in the example of FIG. 4. In some cases, the predetermined time period 420 may be applied in the first slot that is at least Y symbols (e.g., which is RRC-configured based on UE capability) after the last symbol of a control channel transmission (e.g., a physical uplink control channel (PUCCH) transmission) carrying the HARQ-acknowledgment 415. In some cases, the beam indication may be a “sticky” indications in that it is not related to the scheduled shared channel communication (e.g., a physical downlink shared channel (PDSCH) transmission), and it is not a one-time indication. When the beam indication is applied, it remains the same for the applicable channels/signals until changed (e.g., another MAC-CE or DCI format 1_1/1_2 changes the beam). In some cases, the beam indication may be common for multiple downlink channels/signals (e.g., PDSCH, PDCCH, CSI-RS) and/or multiple uplink channels/signals (PUSCH, PUCCH, SRS).

In some examples, as described with reference to FIG. 4, the beam indication may indicate one or two TCI states. A single TCI state (e.g., based on a unified TCI framework) may be applied to a physical channel (e.g., a PDSCH, a PDCCH, a PUSCH, a PUCCH, etc.), but reference signal resources (e.g., CSI-RS resources or SRS resources) may not share the same TCI state. That is, the UE may not apply the same TCI state indicated by the beam indication to SRS or CSI-RS resources. If the applied TCI state is a downlink TCI state or a joint TCI state, a base station (e.g., or network entity) may configure, via RRC signaling, whether the UE is to apply the same TCI state to aperiodic CSI-RS resources. When the applied TCI states is an uplink TCI state or a joint TCI state, the base station (e.g., or network entity) may configure, via RRC signaling, whether to apply the same TCI state to aperiodic SRS resources or resource sets. If CSI-RS resources or SRS resources do not share a same TCI state (e.g., as indicated via RRC signaling), then the base station may provide an indication (e.g., an indication) of the beam that the UE is to use for communicating reference signals (e.g., the beam for reference signals may not be updated together with a beam for other channels, such as a PDSCH, PDCCH, PUSCH, or PUCCH). then the base station may indicate (e.g., via RRC signaling, MAC-CE, etc.) a beam to sue for CSI-RS or SR

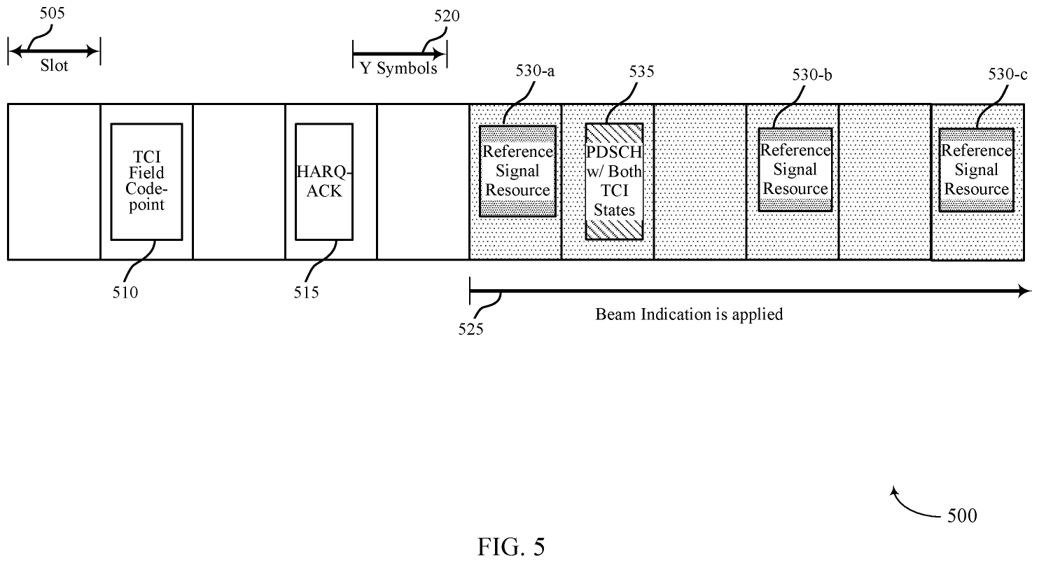

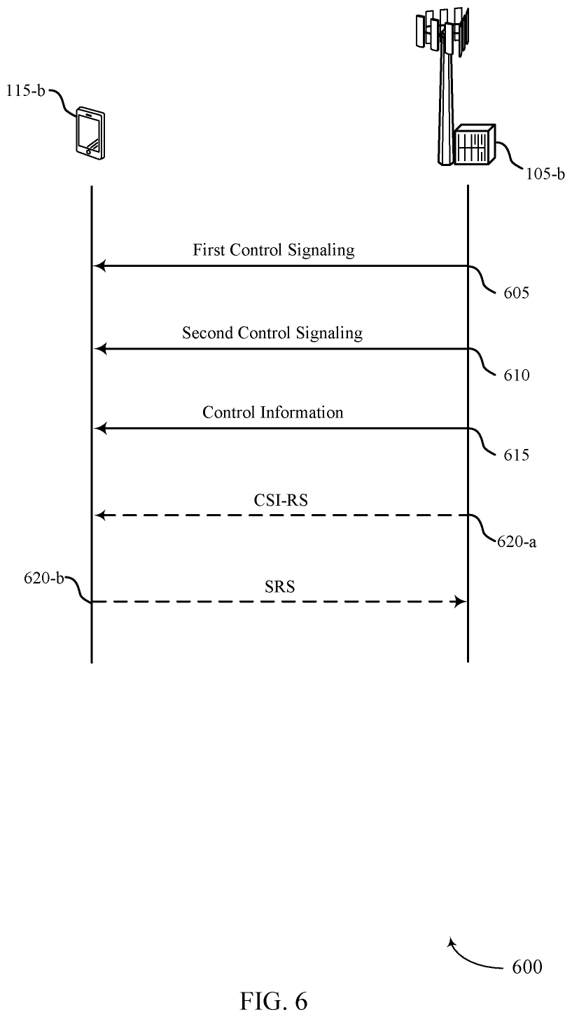

As discussed herein, unified TCI frameworks may be extended to mTRP schemes for indicating two TCI states (e.g., two downlink TCI states, two uplink TCI states, two downlink TCI states and two uplink TCI states, two joint downlink/uplink TCI states, etc.) for different channels and signals. In some cases, two TCI states may be applied to PDSCH/PUSCH/PUCCH transmissions starting after predetermined time period 420 (e.g., the first slot that is at least Y symbols after the last symbol of HARQ-acknowledgment 415). The UE may perform wireless communications on the PDSCH/PUSCH/PUCCH transmissions at 425 using the two TCI states. The UE may also be configured to communicate one or more reference signals at 425 (e.g., to receive one or more CSI-RSs, transmit one or more SRSs, etc., during the time duration to which the beam indication is applied). However, the UE may support communication of such reference signals via a single TCI state. For example, one CSI-RS resource or one SRS resources may only be associated with a single TCI state. It may therefore be desirable for the UE to support techniques described herein to select (e.g., among the two applied TCI states) a TCI state for communicating the reference signals. In some examples, the base station may transmit an indication that a UE is to use one of two applied TCI states (e.g., the first TCI state or the second TCI state of any two applied TCI states) for communicating reference signals, which is described in greater detail with reference to FIGS. 5 and 6. In such examples, the network may indicate (e.g., via RRC signaling, MAC-CE signaling, or DCI signaling), which of two applied TCI states the UE is to apply for CSI-RS or SRS resources. This indication may not indicate a particular TCI state identifier to apply. Instead, such an indication may indicate if a first TCI state of a pair or a second TCI state of a pair is applied. The pair itself (e.g., with two TCI state identifiers) may be indicated through the beam indication mechanisms (e.g., DCI-based or MAC-CE based beam indication) and may change over time (e.g., when a new beam indication is sent), and may be independent from the indication of which of any pair of TCI states the UE is to apply for reference signals.

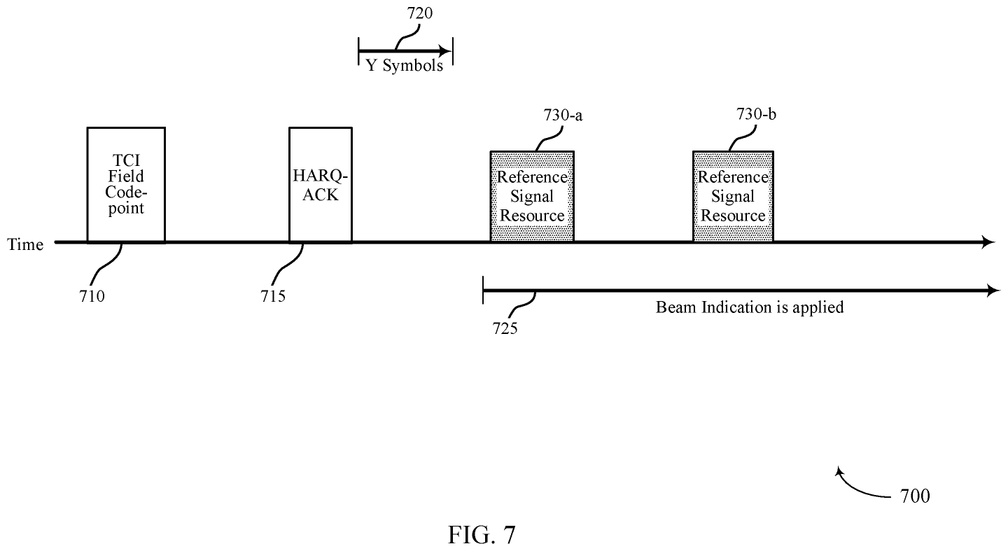

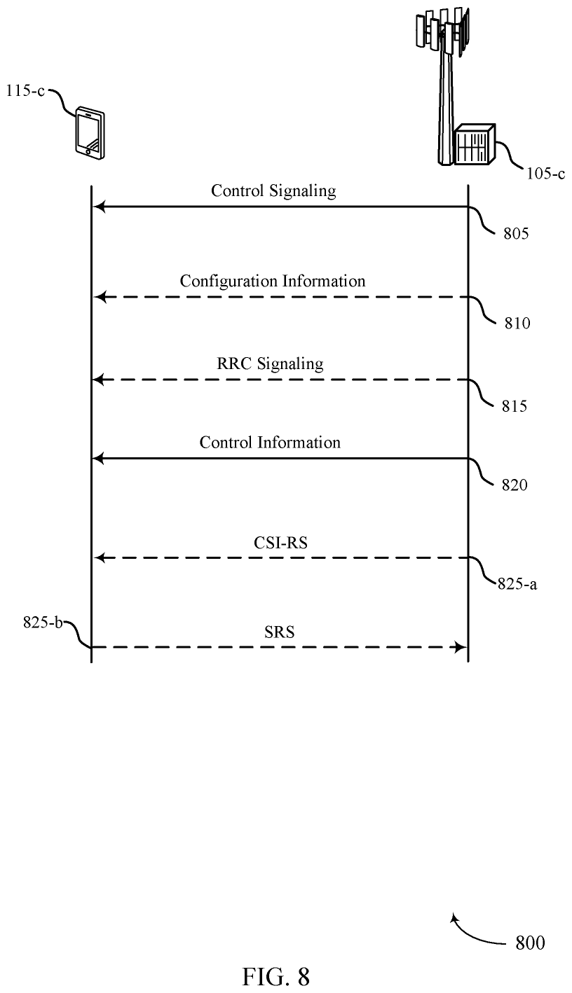

In some examples, the UE may determine which of two TCI states to use for communicating reference signals based on one or more rules, which may be based on one or more index values associated with reference signal resources, as described in greater detail with reference to FIGS. 7 and 8. In such examples of rule-based determination as to which of two TCI states to apply for CSI-RS or SRS signaling, a rule may be based on some sort of lower identifier or higher identifier (e.g., associated with a reference signal resource, a group of reference signal resources, a reference signal resource set, or the like). Such rule-based determinations may be applicable to specific cases in which a grouping already exists (e.g., associations with TRPs, etc.).

FIG. 5 illustrates an example of a timeline 500 that supports reference signal communication in the presence of unified transmission configuration indicator states in accordance with aspects of the present disclosure. The timeline 500 may be implemented by one or more aspects of the wireless communications systems 100 or 200. For example, the timeline 500 may be utilized by one or more TRPs (e.g., base stations or TRPs associated with a base station), and a UE, which may be examples of corresponding devices as described with reference to FIGS. 1-3. Techniques described herein may support a UE determining a beam for CSI-RS or SRS resources when a pair of TCI states (e.g., downlink, uplink, both downlink and uplink, or joint TCI states) are indicated to be applied starting from a given time for PDSCHs, PDCCHs, PUCCHs, or PUSCHs.

In the example of FIG. 5, a UE and TRP may communicate in slots 505. During one slot 505, a base station or other network entity may transmit, and a UE may receive, a DCI with a TCI field codepoint 510. As discussed herein, the TCI field codepoint 510 may indicate a pair of TCI states. For example, one TCI field codepoint 510 may represent a joint downlink/uplink TCI state mapped to one TCI codepoint, which may be used for joint downlink/uplink beam indication. In another example, one TCI field codepoint 510 may represent a pair with a downlink TCI state and uplink TCI state, which may be used for separate downlink/uplink beam indication. In other examples, one TCI field codepoint 510 may represent only a downlink TCI state, which may be used for downlink beam indication, or one TCI field codepoint 510 may represent only an uplink TCI state, which may be used for uplink beam indication. In some cases, if control signaling (e.g., a MAC-CE) indicates the mapping to only a single TCI field codepoint, it may serve as a beam indication, and a separate beam indication in DCI may not be needed. In the case of multi-TRP, the TCI codepoint may represent two different TCI state for a subset of channels or signals (e.g., two joint downlink/uplink TCI states, two downlink only TCI states, two uplink only TCI states, two pairs of downlink and uplink TCI states).

A UE that receives the DCI with the TCI field codepoint 510 may transmit a feedback indication, such as a HARQ-acknowledgment 515, to a base station or TRP that indicates successful receipt of the DCI. In some cases, the beam indication provided in the TCI field codepoint 510 may be applied to communications starting a predetermined time period 520 (e.g., Y symbols) after the HARQ-acknowledgment 515. For example, the beam indication may be applied three milliseconds after HARQ-acknowledgment 515, as indicated at 525 in the example of FIG. 5. In some cases, the predetermined time period 520 may be applied in the first slot that is at least Y symbols (e.g., which is RRC-configured based on UE capability) after the last symbol of a control channel transmission (e.g., PUCCH transmission) carrying the HARQ-acknowledgment 5415. In some cases, the beam indication may be a “sticky” indication in that it is not related to the scheduled shared channel communication (e.g., a PDSCH transmission), and it is not a one-time indication. When the beam indication is applied, it may remain the same for the applicable channels/signals for time 525 until changed (e.g., MAC-CE or DCI format 1_1/1_2 changes the beam). In some cases, the beam indication may be common for multiple downlink channels/signals (e.g., PDSCH, PDCCH, CSI-RS) and/or multiple uplink channels/signals (PUSCH, PUCCH, SRS).

In some examples, the TCI field codepoint 510 may indicate a pair of TCI states to be applied starting from a given time (e.g., for the duration of time 525) for some channels. The UE may apply one of the two TCI states for a given CSI-RS resource or resource set and a given SRS resource or resource set based on an indication from the network as to whether one of the two TCI states are to be applied, and if so, which of the two TCI states is to be applied. For example, the TCI field codepoint 510 may indicate a pair of TCI states that are downlink TCI states or joint TCI states. In such examples, one or more reference signal resources 530 may be CSI-RS resources associated with one or more CSI-RS resource sets. For example, the UE may use the pair of TCI states to receive downlink data signaling via the PDSCH 535 (e.g., with both TCI states).

In some examples, the indication of which TCI state to apply for CSI-RS may be based on RRC configuration. An RRC message may indicate a behavior (e.g., which TCI state the UE is to apply) on a per component carrier or per bandwidth part basis. For example, if the reference signal resource 530-a and the reference signal resource 530-b are located in a same BWP or a same component carrier, the base station may instruct the UE via the RRC message to apply the same behavior (e.g., use the same TCI state of a pair of TCI states) for all CSI-RS resources (e.g., including the reference signal resource 530-a and the reference signal resource 530-b) within the BWP or component carrier. In some examples the RRC message may indicate a behavior (e.g., which TCI state the UE is to apply) per CSI-RS resource set or per CSI-RS resource. For instance, the base station may indicate, via RRC signaling, that a first CSI-RS resource set including the reference signal resource 530-a, or a first CSI-RS resource (e.g., the reference signal resource 530-a) is associated with (e.g., shares) the first TCI state of a pair of TCI states. The base station may also indicate, via RRC signaling that a second CSI-RS resource set including the reference signal resource 530-b, or a second CSI-RS resource (e.g., the reference signal resource 530-b) is associated with (e.g., shares) the second TCI state of a pair of TCI states. In such examples, the UE may apply the first TCI state of the two TCI states indicated via the TCI field codepoint 510 to the reference signal resources 530-a (e.g., may receive CSI-RS using the first TCI state) and may apply the second TCI state of the two TCI states to the reference signal resources 530-b (e.g., may receive CSI-RS using the second TCI state). In some examples, the indication of a behavior may include an indication of which identifier the UE is to associate with a given TCI state. For example, the RRC signaling may indicate that the UE is to apply a first TCI state to a CSI-RS resource or CSI-RS resource set having a lower identifier value (e.g., a lower index value) and to apply a second TCI state to a CSI-RS resource or CSI-RS resource set having a higher identifier value (e.g., a higher index value).

In some examples, the indication of which TCI state to apply for CSI-RS may be based on a MAC-CE message. The MAC-CE may indicate (e.g., may activate) one or more semi-persistent CSI-RS resource sets. For example, a MAC-CE that activates a given semi-persistent CSI-RS resource set may include an indication of a number of bits indicating whether the UE is to apply a first TCI state or a second TCI state of a pair of TCI states to the CSI-RS resources activated by the MAC-CE. In some examples, a first MAC-CE may activate a CSI-RS resource set, and a second MAC-CE may indicate whether the activated CSI-RS resource set is associated with a first TCI state or a second TCI state of a pair of TCI states. The indication of behavior may be based at least in part on an identifier associated with the activated semi-persistent CSI-RS resource set (e.g., a lower index value may be associated with one of the two TCI states and a higher index value may be associated with the other of the two TCI states).

In some examples, the indication of which TCI state to apply for CSI-RS may be based on a DCI indication. A DCI message may indicate an aperiodic CSI-RS resource set (e.g., may trigger an aperiodic CSI-RS resource set and aperiodic CSI report). The DCI indication that triggers aperiodic CSI-RS resource set and aperiodic CSI report may also indicate which TCI state of a pair of TCI states the UE is to apply for one or more reference signal resources 530. For example, the DCI message may indicate that a CSI-RS resource set including both the reference signal resource 530-a and the reference signal resource 530-b is associated with a first TCI state, in which case the UE may use both the reference signal resource 530-a and the reference signal resource 530-b to receive CSI-RSs using the first TCI state. The indication of behavior may be based at least in part on an identifier associated with the indicated aperiodic CSI-RS resource set (e.g., a lower index value may be associated with one of the two TCI states and a higher index value may be associated with the other of the two TCI states).

In some examples, if a reference signal resource is not indicated by an RRC message, a MAC-CE, or a DCI indication, then the base station may transmit a separate beam indication for the CSI-RS resource (e.g., the reference signal resource 530-c) or CSI-RS resource set (e.g., including the reference signal resource 530-c) that does not share any of the pair of TCI states. For example, if the RRC message indicates that the reference signal resource 530-a shares the first TCI state and the reference signal resource 530-b shares the second TCI state (e.g., but does not indicate that the reference signal resource 530-c or a reference signal resource set including the reference signal resource 530-c is associated with a particular TCI state), then the base station may provide, to the UE, a beam indication for the UE to use for communicating reference signals via the reference signal resource 530-c.

Techniques described with reference to FIG. 5 may be applied for SRS resources. For example, the pair of TCI states may be a pair of uplink TCI states or joint TCI states. The reference signal resources 530 may be SRS resources, or may correspond to one or more SRS resource sets. The indication from the network (e.g., indicating which TCI state of the pair of TCI states the UE is to apply for the SRS resources) may be based at least in part on RRC configuration. The RRC configuration may be per component carrier or bandwidth part (e.g., the same behavior is followed for all SRS resources in the component carrier or BWP). The RRC configuration may be per SRS resource set, or per SRS resource. The UE may transmit SRSs on the SRS resources using the TCI state of the pair of TCI states per the indication received via the RRC signaling.

The indication from the network may be based at least in part on MAC-CE signaling. Such indication may be applicable to semi-persistent SRS resource sets (e.g., a MAC-CE may activate a given semi-persistent SRs resource set). The UE may transmit SRSs via the SRS resources using the TCI state of the pair of TCI states indicated in the MAC-CE.

The indication from the network may be based at least in part on a DCI indication. Such indications may be applicable to aperiodic SRS resource sets. For example, the DCI message that triggers an aperiodic SRS resource set may indicate which of the two TCI states should be applied to the activated SRS resource set. The UE may then transmit SRSs via the activated SRS resource set using the TCI state indicated in the DCI message.

In some examples, for an SRS resource or SRS resource set that does not share any of the TCI states of the beam indication, the base station may provide a separate beam indication configuring the UE with a TCI state to use for transmitting SRSs via the SRS resource or SRS resource set.

FIG. 6 illustrates an example of a process flow 600 that supports reference signal communication in the presence of unified transmission configuration indicator states in accordance with aspects of the present disclosure. Process flow 600 may implement aspects of, or may be implemented by aspects of, wireless communications system 100 and wireless communications system 200. For example, process flow 600 may include a network device (e.g., such as base station 105-b) and a UE 115-b, which may be examples of corresponding devices described with reference to FIGS. 1-5. Signaling described with reference to FIG. 6 between the UE 115-b and the base station 105-b may include transmissions between the UE 115-b and one or more network entities (e.g., one or more TRPs in an mTRP deployment).

At 605, the base station 105-b may transmit, and the UE 115-b may receive, first control signaling. The first control signaling may identify two or more TCI states that are to be applied to communications of one or more channels subsequent to a determined time (e.g., applied to channels or signals after an amount of time subsequent to transmission of HARQ feedback by the UE 115-b). The two or more TCI states may provide for mTRP communication with two or more TRPs associated with the base station 105-b.

At 610, the base station 105-b may transmit, and the UE 115-b may receive, second control signaling. The second control signaling may include an indication of which TCI state of a pair of TCI states the UE is to apply for communicating reference signals. The second control signaling may be an RRC message including the indication. The indication may be associated with a component carrier or a BWP (e.g., may be a per BWP or per component carrier indication). The indication may be associated with a reference signal resource set (e.g., a CSI-RS resource set or an SRS resource set) or may be associated with a reference signal resource (e.g., a CSI-RS resource or an SRS resource). In some examples, the second control signaling may be MAC-CE including the indication. The MAC-CE may activate the one or more reference signal resources (e.g., may activate a semi-persistent CSI-RS resource set or a semi-persistent SRS resource set). In some examples, the second control signaling may be a DCI message. The DCI message may include the indication, and may trigger an aperiodic reference signal resource set (e.g., which may include the one or more reference signal resources). In some examples the indication may include an instruction to apply a TCI state of a pair of TCI states that is associated with a lowest index value (e.g., a TCI state index value, or an index value associated with a resource or resource set).

At 615, the base station 105-b may transmit, and the UE 115-b may receive, control information (e.g., a an RRC message triggering periodic reference signal resources, a MAC-CE triggering semi-persistent reference signal resources, a DCI message triggering aperiodic reference signal resources) associated with one or more resource allocations for communications after the determined time according to two TCI states of the two or more TCI states. The one or more resources may be associated with one or more reference signal resources (e.g., CSI-RS resources or SRS resources). The control information may be a DCI that indicates allocated resources for communications. The one or more channels may include a PDSCH, a PUSCH, a PUCCH, a PDCCH, or a combination thereof. The first control signaling may be a DCI with a TCI state field, or a MAC-CE that indicates a codepoint mapped to the TCI states.

At 620, the UE 115-b may communicate according to one (e.g., the first) TCI state of the two TCI states via the reference signal resources based on the indication received at 610. In some examples, the communicating may include receiving reference signals. For example, at 620-a, the UE 115-b may receive one or more CSI-RSs via the one or more reference signal resources. In such examples, the two TCI states may be a pair of downlink TCI states or a pair of joint TCI states. In some examples, the communicating may include transmitting reference signals. For instance, at 620-b, the UE 115-b may transmit one or more SRSs via the one or more reference signal resources. In such examples, the two TCI states may be a pair of uplink TCI states or a pair of joint TCI states.

FIG. 7 illustrates an example of a timeline 700 that supports reference signal communication in the presence of unified transmission configuration indicator states in accordance with aspects of the present disclosure. The timeline 700 may be implemented by one or more aspects of the wireless communications systems 100 or 200. For example, the timeline 700 may be utilized by one or more TRPs (e.g., base stations or TRPs associated with a base station), and a UE, which may be examples of corresponding devices as described with reference to FIGS. 1-6. Techniques described herein may support a UE determining a beam for CSI-RS or SRS resources when a pair of TCI states (e.g., downlink, uplink, both downlink and uplink, or joint TCI states) are indicated to be applied starting from a given time for PDSCHs, PDCCHs, PUCCHs, or PUSCHs.

In the example of FIG. 7, a UE and TRP may communicate in one or more slots. A base station may transmit, and the UE may receive, a DCI that indicates a TCI field codepoint 710. As discussed herein, the TCI field codepoint 710 may be mapped to one or multiple TCI states (e.g., one or more uplink TCI states, one or more downlink TCI states, or any combinations thereof). For example, one TCI field codepoint 710 may represent a joint downlink/uplink TCI state mapped to one TCI codepoint, which may be used for joint downlink/uplink beam indication. In another example, one TCI field codepoint 710 may represent a pair with a downlink TCI state and uplink TCI state, which may be used for separate downlink/uplink beam indication. In other examples, one TCI field codepoint 710 may represent only a downlink TCI state, which may be used for downlink beam indication, or one TCI field codepoint 710 may represent only an uplink TCI state, which may be used for uplink beam indication. In some cases, if the MAC-CE indicates the mapping to only a single TCI field codepoint, it may serve as a beam indication, and a separate beam indication in DCI may not be needed.

A UE that receives the DCI with the TCI field codepoint 710 may transmit a feedback indication, such as a HARQ-acknowledgment 715, to a base station or TRP that indicates successful receipt of the DCI. In some cases, the beam indication provided in the TCI field codepoint 710 may be applied to communications starting a predetermined time period 720 (e.g., Y symbols) after the HARQ-acknowledgment 715. For example, the beam indication may be applied three milliseconds after HARQ-acknowledgment 715, as indicated at 725 in the example of FIG. 7. In some cases, the predetermined time period 720 may be applied in the first slot that is at least Y symbols (e.g., which is RRC-configured based on UE capability) after the last symbol of a control channel transmission (e.g., PUCCH transmission) carrying the HARQ-acknowledgment 715. In some cases, the beam indication may be a “sticky” indication in that it is not related to the scheduled shared channel communication (e.g., a PDSCH transmission), and it is not a one-time indication. When the beam indication is applied, it may remain the same for the applicable channels/signals for time 725 until changed (e.g., a MAC-CE or DCI format 1_1/1_2 changes the beam). In some cases, the beam indication may be common for multiple downlink channels/signals (e.g., PDSCH, PDCCH, CSI-RS) and/or multiple uplink channels/signals (PUSCH, PUCCH, SRS).

In some examples, the TCI field codepoint 710 may indicate a pair of TCI states to be applied starting from a given time (e.g., for the duration of time 725) for some channels. The UE may apply one of the two TCI states for a given CSI-RS resource or resource set and a given SRS resource or resource set based on one or more rules defining which of the two TCI states is to be applied. For example, the TCI field codepoint 710 may indicate a pair of TCI states that are downlink TCI states or joint TCI states. In such examples, one or more reference signal resources 730 may be CSI-RS resources associated with one or more CSI-RS resource sets.

A base station may configure a CSI-RS resource set in two groups (e.g., a NZP CSI-RS resource set for channel measurement consists of two groups, with K₁≥1 resources in group 1 and K₂≥1 resources in group 2). For example, reference signal resource 730-a may be a CSI-RS resource in group 1, and reference signal resource 730-b may be a CSI-RS resource in group 2, Group 1 may be associated with a first index value and group 2 may be associated with a second index value. For the CSI-RS resources in group 1 (e.g., including the reference signal resource 730-a), the UE may apply the first TCI state of the pair (e.g., based on the lower index value). For the CSI-RS resources in group 2 (e.g., including the reference signal resource 730-b), the UE may apply the second TCI state of the pair (e.g., based on the higher index value).

In some examples, applying such a rule to determine which TCI state to use may be based on one or more conditions being satisfied. For example, the UE may apply the TCI state (e.g., the first TCI state or the second TCI state) based on the rule if one or more conditions are satisfied. The UE may apply one of the two TCI states according to the rule (e.g., based on the index values of the groups of a CSI-RS resource set) if the CSI-RS resources are configured to share a same beam indication. Configuration information to share same began indication may be performed via RRC configuration, indicating whether to share a beam indication for CSI-RS or to rely on independent beam indications for specific CSI-RS resources or CSI-RS resource sets In some examples, the UE may apply one of the two TCI states according to the rule if the CSI-RS resources are aperiodic CSI-RS resources (e.g., the wireless communications system may support sharing of beam indication for aperiodic CSI-RSs) In some examples, the UE may apply one of the two TCI states according to the rule if a group consists of only one CSI-RS resource (e.g., K₁=1 or K₁=1), or if the groups consist of only two CSI-RS resources and only one of them belongs to a resource pair while the other one does not belong to a resource pair. For example, if there are more than one CMR in a CMR group, applying a same beam may not efficiently use computational resources (e.g., CPU, resource utilization, port occupation, or the like) because if two groups have a same beam and a same usage (e.g., non-coherent joint transmission (NCJT) versus sTRP), all other aspect may also be the same. In such examples, it may be more beneficial to individually configure TCI states for CSI-RS resources or CSI-RS resource sets via beam indications.

Reverting to a fallback signaling protocol (e.g., individual beam indications for CSI-RS resources or resource sets) may be supported where, for mTRP or NCJT CSI, two channel measurement resource (CMR) groups within a CSI-RS resource set are configured. Within the CSI-RS resource set in a given CSI report configuration, one or more pairs of CSI-RS resources may be configured for one or more NCJT CSI hypothesis. CMRs may be divided into two groups, and each CMR pair (e.g., corresponding to an NCJT hypothesis) may consist of one CMR in the first group and one CMR in the second group. Each CMR may be used for NCJT CSI hypothesis (e.g., in a pair), or a single TRP CSI hypothesis.

In some examples, a base station may configure multiple CSI-RS resource sets. For example, the base station may configure, at the UE, a first CSI-RS resource set including the reference signal resource 730-a, and may configure a second CSI-RS resource set including the reference signal resources 730-b. The first CSI-RS resource set may be associated with a first identifier (e.g., a first index value) and the second CSI-RS resource set may be associated with a second identifier (e.g., a second index value). In such examples, the UE may determine which TCI state of the pair of TCI states indicated by the TCI field codepoint 710 based on a rule. The rule may indicate that the UE is to apply a TCI state to a CSI-RS resource set based on the index values of the respective CSI-RS resource sets. In some cases, the UE may apply the rule (e.g., based on the index values of the CSI-RS resource sets) if the UE is configured with an RRC parameter (e.g., the RRC parameter gruopBasedBeamReporting-r17) for a given CSI report configuration, if the two CSI-RS resource sets for channel measurement are configured, and if the pair of TCI states are downlink TCI states or joint TCI states. In such examples, for the CSI-RS resources in the first CSI-RS resource set (e.g., the reference signal resource 730-a), the UE may apply the first TCI state of the pair. For the CSI-RS resources in the second CSI-RS resource set (e.g., the reference signal resource 730-b), the UE may apply the second TCI state of the pair.

In some examples, the UE may apply such a rule (e.g., applying a TCI state to CSI-RS resources of a CSI-RS resource set based on the index value of the CSI-RS resource set) if one or more conditions are satisfied. For example, the UE may apply the rule if the CSI-RS resources are configured to share the same beam indication. The base station may configure the UE (e.g., via RRC signaling) as to whether to share a beam indication for CSI-RS or to follow a different protocol (e.g., individual beam indications for CSI-RS resources). The UE may apply the rule if the CSI-RS resources are aperiodic CSI-RS resources (e.g., the wireless communications system may support shared beam indications for aperiodic CSI-RS). The UE may apply the rule if CSI-RS resource sets include only one CSI-RS resource or a number of reported reference signal groups is configured to be one (e.g., if there are more CSI-RS resources in a resource set, the UE may not apply the same beam to all resources in the resource set). In some examples, for the UE to report which two beams can be received simultaneously, the UE may support enhanced group-based beam reporting. If the UE is configured with a higher layer parameter groupBasedBeamReporting, then the UE may report a single reporting instance (e.g., nrofReportedRSgroup groups of two CRIs selecting one CSI-RS from each of the two CSI resource sets for the report setting (e.g., where CSI-RS resources of each group may be received simultaneously by the UE). The UE may also report a corresponding layer 1 (L1) reference signal received power (RSRP) for the two selected CSI-RS resources for each reported group.

In some examples, the base station may configure the UE with two SRS resource sets. In such examples, the TCI states may be uplink TCI states or joint TCI states, and the reference signal resources may be SRS resources. The base station may configure the two SRS resource sets with a higher layer parameter (e.g., the higher layer parameter usage in an SRS-ResourceSet set to codebook or noncodebook). The first SRS resource set may include the reference signal resource 730-a and the second SRS resource set may include the reference signal resource 730-b. The first SRs resource set may be associated with a first identifier (e.g., a first index value) and the second SRs resource set may be associated with a second identifier (e.g., a second index value) For the SRS resources in the first SRS resource set (e.g., the SRS resource set with the lower index value), the UE may apply the first TCI state of the pair. For the SRS resource in the second SRS resource set (e.g., the SRS resource set with the higher index value), the UE may apply the second TCI state of the pair of TCI states. The two SRS resource sets may be configured corresponding to scheduling by DCI format 0_1 (e.g., may be configured in srs-ResourceSet ToAddModList) or corresponding to scheduling by DCI format 0_2 (e.g., configured in srs-ResourceSetToAddModLIstDCI-0-2) or both. In some examples, the UE may apply a rule (e.g., apply a TCI state to an SRS resource set based on the index values of the SRS resource sets) for DCI format 0_1 or DCI format 0_2, or other DCI formats. If the base station configures only one SRS resource set for a given DCI format (e.g., only a single SRS resource set configured in srs-ResourceSetToAddModList) with usage set to codebook or noncodebook, the UE may apply the first TCI state of the pair of TCI states to the SRS resources of the single SRS resource set.

In some examples, the UE may apply the rule (e.g., applying a TCI state to an SRS resource set based on the index value of the SRS resource set) if one or more conditions are satisfied. For example, the UE may apply the rule if SRS is configured to share a same beam indication. The UE may apply the rule for aperiodic SRS resource sets (e.g., but not for semi-persistent SRS resource sets).

The UE may apply the rule when two SRS resource sets are configured. For example, for mTRP PUSCH repetitions, two SRS resource sets (e.g., associated with two sets of PUSCH repetitions) may be RRC-configured with usage set to codebook or noncodebook. The first SRS resource set may be defined as the SRS resource set having the lower identifier (e.g., the lower index value) and the second SRS resource set may be defined as the SRS set having the higher identifier (e.g., the higher index value). The first and second SRS resource sets for mTRP PUSCH may be separately defined for DCI format 0_1 and DCI format 0_2. In some cases, the two SRS resource sets may be configured in each of srs-ResourceSetToAddModList and srs-ResourceSetToAddModListDCI-0-2. In some cases, one SRS resource set may be configured in srs-ResourceSetToAddModList but two SRS resource sets may be configured in srs-ResourceSetToAddModListDCI-0-2. In some examples, two SRS resource sets may be configured in srs-ResourceSetToAddModList but one SRS resource set may be configured in SRS-ResourceSetToAddModLIstDCI-0-2.

In some examples, the UE may apply a TCI state to a CSI-RS resource or CSI-RS resource set based on a rule (e.g., based on an index value of a CSI-RS resource set). For example, the base station may configure two NZP-CSI-RS-Resource sets via a higher layer parameter (e.g., trs-Info). The first of the two CSI-RS resource sets may be associated with a first identifier (e.g., a first index value) and the second of the two CSI-RS resource sets may be associated with a second identifier (e.g., a second index value). The pair of TCI states may be downlink TCI states or joint TCI states. In such examples, for the CSI-RS resources in the NZP-CSI-RS resource set with the lower identifier (e.g., the lower index value), the UE may apply the first TCI state of the pair of TCI states. For the CSI-Rs resource in the NZP-CSI-RS resource set with the higher identifier (e.g., the higher index value), the UE may apply the second TCI state of the pair.

In some examples, the base station may configure two NZP-CSI-RS resource sets with a higher layer parameter (e.g., the higher layer parameter repetition), and the pair of TCI states may be downlink TCI states or joint TCI states. The first of the two CSI-RS resource sets may be associated with a first identifier (e.g., a first index value) and the second of the two CSI-RS resource sets may be associated with a second identifier (e.g., a second index value). The pair of TCI states may be downlink TCI states or joint TCI states. In such examples, for the CSI-RS resources in the NZP-CSI-RS resource set with the lower identifier (e.g., the lower index value), the UE may apply the first TCI state of the pair of TCI states. For the CSI-RS resource in the NZP-CSI-RS resource set with the higher identifier (e.g., the higher index value), the UE may apply the second TCI state of the pair.

In some examples, the base station may configure two SRS resource sets via a higher layer parameter (e.g., the higher layer parameter usage in SRS-ResourceSet set to ‘beamManagement’ or ‘antennaSwitching’. The first of the two SRS resource sets may be associated with a first identifier (e.g., a first index value) and the second of the two SRS resource sets may be associated with a second identifier (e.g., a second index value). The pair of TCI states may be uplink TCI states or joint TCI states. In such examples, for the SRS resources in the SRS resource set with the lower identifier (e.g., the lower index value), the UE may apply the first TCI state of the pair of TCI states. For the SRS resource in the SRS resource set with the higher identifier (e.g., the higher index value), the UE may apply the second TCI state of the pair. In some examples, for CSI-RS for TRS or beam management or the like (e.g., with repetition on), or for SRS for beam management or antenna switching, there reference signal resource sets may be defined with differentiable identifiers (e.g., index values that are higher or lower than each other).

FIG. 8 illustrates an example of a process flow 800 that supports reference signal communication in the presence of unified transmission configuration indicator states in accordance with aspects of the present disclosure. Process flow 800 may implement aspects of, or may be implemented by aspects of, wireless communications system 100 and wireless communications system 200. For example, process flow 800 may include a network device (e.g., such as base station 105-c) and a UE 115-d, which may be examples of corresponding devices described with reference to FIGS. 1-7. Signaling described with reference to FIG. 8 between the UE 115-c and the base station 105-c may include transmissions between the UE 115-c and one or more network entities (e.g., one or more TRPs in an mTRP deployment).

At 805, the base station 105-c may transmit, and the UE 115-c may receive, first control signaling. The first control signaling may identify two or more TCI states that are to be applied to communications of one or more channels subsequent to a determined time (e.g., applied to channels or signals after an amount of time subsequent to transmission of HARQ feedback by the UE 115-c). The two or more TCI states may provide for mTRP communication with two or more TRPs associated with the base station 105-c.

At 810, the base station 105-c may transmit, and the UE 115-c may receive, configuration information. For example, the base station 105-c may transmit second control signaling configuring a first set of one or more reference signal resources and a second set of one or more reference signal resources. The first set of one or more reference signal resources may be associated with a first identifier and the second set of one or more reference signal resources may be associated with a second identifier. The first set of one or more reference signal resources may be a first group of reference signal resources within a reference signal resource set (e.g., a first group of CSI-RS resources of a CSI-RS resource set) and the second set of one or more reference signal resources may be a second group of reference signal resources within the reference signal resource set (e.g., a second group of CSI-RS resources of the CSI-RS resource set). In some examples, the first set of one or more reference signal resources may be a first reference signal resource set (e.g., a CSI-RS resource set or an SRS resource set) and the second set of one or more reference signal resources may be a second reference signal resource set (e.g., a CSI-RS resource set or an SRS resource set).

At 820, the base station 105-c may transmit, and the UE 115-c may receive, control information (e.g., an RRC message triggering periodic reference signal resources, a MAC-CE triggering semi-persistent reference signal resources, a DCI message triggering aperiodic reference signal resources) associated with one or more resource allocations for communications after the determined time according to two TCI states of the two or more TCI states. The one or more resources may be associated with one or more reference signal resources (e.g., CSI-RS resources or SRS resources). The control information may be a DCI that indicates allocated resources for communications. The one or more channels may include a PDSCH, a PUSCH, a PUCCH, a PDCCH, or a combination thereof. The first control signaling may be a DCI with a TCI state field, or a MAC-CE.

At 825, the UE 115-c may communicate according to one (e.g., the first) TCI state of the two TCI states via the reference signal resources based on a rule. The UE may communicate the reference signals via the first set of one or more reference signal resources according to the first TCI state based on the first identifier associated with the first set of one or more reference signal resources, and via the second set of one or more reference signal resources according to the second TCI state based at least in part on the second identifier associated with the second set of one or more reference signal resources. In some examples, the communicating may include receiving reference signals. For example, at 825-a, the UE 115-c may receive one or more CSI-RSs via the one or more reference signal resources. In such examples, the two TCI states may be a pair of downlink TCI states or a pair of joint TCI states. In some examples, the communicating may include transmitting reference signals. For instance, at 825-b, the UE 115-c may transmit one or more SRSs via the one or more reference signal resources. In such examples, the two TCI states may be a pair of uplink TCI states or a pair of joint TCI states. The UE may apply the first TCI state to the first set of one or more reference signal resources and the second TCI state to the second set of one or more reference signal resources based on the rule. The rule may define behavior such that the UE applies the first and second TCI states to the first and second sets of reference signal resources based on the identifiers (e.g., which identifier is higher or lower) of the respective sets of reference signal resources.

In some examples, the UE 115-c may apply the rule if one or more conditions are satisfied. For example, the UE 115-c may apply the rule if it receives RRC signaling at 815 configuring the UE 115-c to share a same beam indication (e.g., for CSI-RS or SRS resources). In some examples, the UE 115-c may apply the rule if the reference signal resources are aperiodic (e.g., but not if the reference signal resources are semi-persistent scheduled reference signal resources or periodic reference signal resources).

In some examples, the UE 115-c may apply the rule based on a number of reference signal resources in the first set or the second set of one or more reference signal resources, or both. In some examples, the UE may apply the rule if an RRC message is received (e.g., via RRC signaling at 815). For example, the UE may receive (e.g., at 815), an RRC parameter configuring the first set of one or more reference signals and the second set of one or more reference signal resources associated with repetition, tracking reference signal (TRS) reception, beam management, antenna switching, codebook-based uplink transmission, non-codebook based uplink transmissions, or a combination thereof. The rule may be based on the lower SRS resource set identifier or higher SRS resource set identifier. These may be applied separately to SRS resource sets (e.g., that are configured for codebook or non-codebook uplink transmissions configured for DCI format 0_1, or DCI format 0_2). This may result in having up to four SRS resource sets across both DCI formats, but the UE may still apply the higher/lower identifier rule separately for each two SRS resource sets configure for a given DCI format. In some examples, two SRS resource sets may be configured for one of the DCI formats and only one SRS resource set may be configured for the other DCI format. In such examples, for the single SRS resource set for that DCI format the UE 115-c may apply the first TCI state of the pair (e.g., a fixed one of the two TCI states). But, for the other pair of SRS resource sets, the UE may still apply the rule that is based on the higher or lower identifier of the two SRS resource sets.

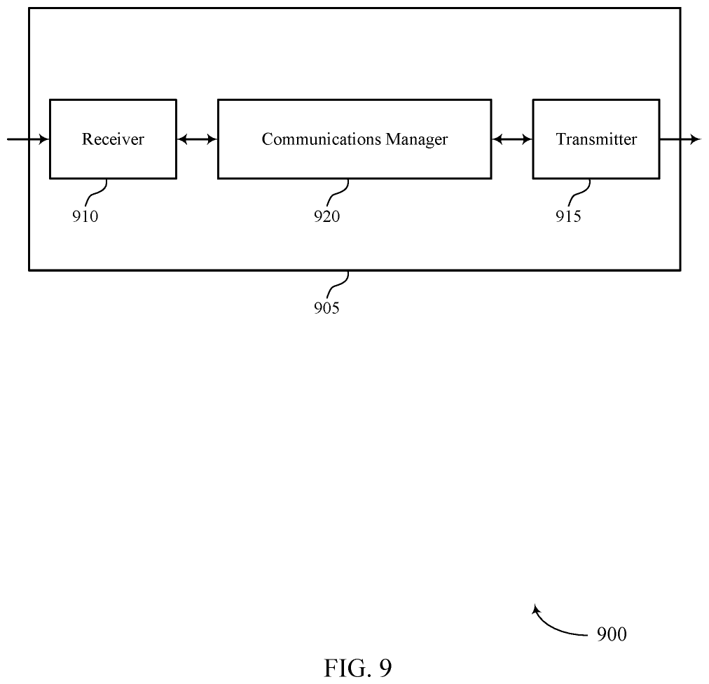

FIG. 9 shows a block diagram 900 of a device 905 that supports reference signal communication in the presence of unified transmission configuration indicator states in accordance with aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to reference signal communication in the presence of unified transmission configuration indicator states). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to reference signal communication in the presence of unified transmission configuration indicator states). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of reference signal communication in the presence of unified transmission configuration indicator states as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software) executed by a processor. If implemented in code executed by a processor, the functions of the communications manager 920, the receiver 910, the transmitter 915, or various combinations or components thereof may be performed by a general-purpose processor, a DSP, a central processing unit (CPU), a graphics processing unit (GPU) an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a UE in accordance with examples as disclosed herein. For example, the communications manager 920 may be configured as or otherwise support a means for receiving, from a network entity, first control signaling identifying two or more transmission configuration indicator states that are to be applied to communications of one or more channels subsequent to a determined time. The communications manager 920 may be configured as or otherwise support a means for receiving, from the network entity, second control signaling including an indication of which transmission configuration indicator state of a pair of transmission configuration indicator states the UE is to apply for communicating reference signals. The communications manager 920 may be configured as or otherwise support a means for receiving, from the network entity, control information associated with one or more resource allocations for communications after the determined time according to two transmission configuration indicator states of the two or more transmission configuration indicator states, the one or more resource allocations associated with one or more reference signal resources. The communications manager 920 may be configured as or otherwise support a means for communicating according to a first transmission configuration indicator state of the two transmission configuration indicator states via the one or more reference signal resources based on the indication.

Additionally, or alternatively, the communications manager 920 may support wireless communications at a UE in accordance with examples as disclosed herein. For example, the communications manager 920 may be configured as or otherwise support a means for receiving, from a network entity, first control signaling identifying two or more transmission configuration indicator states that are to be applied to communications of one or more channels subsequent to a determined time. The communications manager 920 may be configured as or otherwise support a means for receiving, from the network entity, control information associated with one or more resource allocations for communications after the determined time according to a first transmission configuration indicator state and a second transmission configuration indicator state of the two or more transmission configuration indicator states, the one or more resource allocations associated with a first set of one or more reference signal resources and a second set of one or more reference signal resources. The communications manager 920 may be configured as or otherwise support a means for communicating via the first set of one or more reference signal resources according to the first transmission configuration indicator state based on a first identifier associated with the first set of one or more reference signal resources and via the second set of one or more reference signal resources according to the second transmission configuration indicator state based on a second identifier associated with the second set of one or more reference signal resources.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for applying one of a pair of configured TCI states for communicating reference signals, resulting in improved reference signal communications, improved channel estimation, improved reliability of wireless communications, more efficient use of computational resources, and improved user experience.

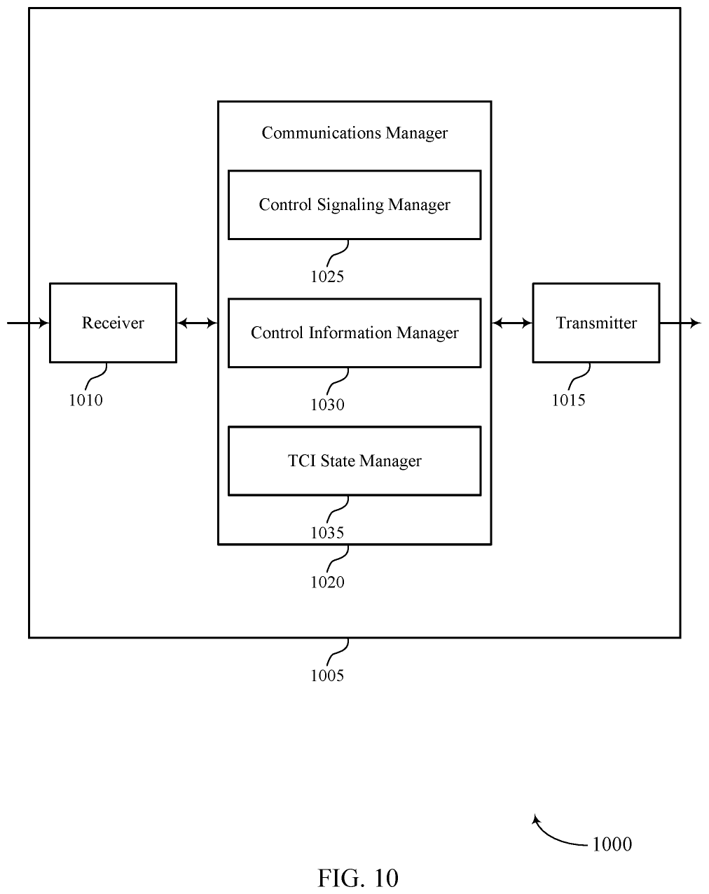

FIG. 10 shows a block diagram 1000 of a device 1005 that supports reference signal communication in the presence of unified transmission configuration indicator states in accordance with aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to reference signal communication in the presence of unified transmission configuration indicator states). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to reference signal communication in the presence of unified transmission configuration indicator states). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of reference signal communication in the presence of unified transmission configuration indicator states as described herein. For example, the communications manager 1020 may include a control signaling manager 1025, a control information manager 1030, a TCI state manager 1035, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a UE in accordance with examples as disclosed herein. The control signaling manager 1025 may be configured as or otherwise support a means for receiving, from a network entity, first control signaling identifying two or more transmission configuration indicator states that are to be applied to communications of one or more channels subsequent to a determined time. The control signaling manager 1025 may be configured as or otherwise support a means for receiving, from the network entity, second control signaling including an indication of which transmission configuration indicator state of a pair of transmission configuration indicator states the UE is to apply for communicating reference signals. The control information manager 1030 may be configured as or otherwise support a means for receiving, from the network entity, control information associated with one or more resource allocations for communications after the determined time according to two transmission configuration indicator states of the two or more transmission configuration indicator states, the one or more resource allocations associated with one or more reference signal resources. The TCI state manager 1035 may be configured as or otherwise support a means for communicating according to a first transmission configuration indicator state of the two transmission configuration indicator states via the one or more reference signal resources based on the indication.

Additionally, or alternatively, the communications manager 1020 may support wireless communications at a UE in accordance with examples as disclosed herein. The control signaling manager 1025 may be configured as or otherwise support a means for receiving, from a network entity, first control signaling identifying two or more transmission configuration indicator states that are to be applied to communications of one or more channels subsequent to a determined time. The control information manager 1030 may be configured as or otherwise support a means for receiving, from the network entity, control information associated with one or more resource allocations for communications after the determined time according to a first transmission configuration indicator state and a second transmission configuration indicator state of the two or more transmission configuration indicator states, the one or more resource allocations associated with a first set of one or more reference signal resources and a second set of one or more reference signal resources. The TCI state manager 1035 may be configured as or otherwise support a means for communicating via the first set of one or more reference signal resources according to the first transmission configuration indicator state based on a first identifier associated with the first set of one or more reference signal resources and via the second set of one or more reference signal resources according to the second transmission configuration indicator state based on a second identifier associated with the second set of one or more reference signal resources.

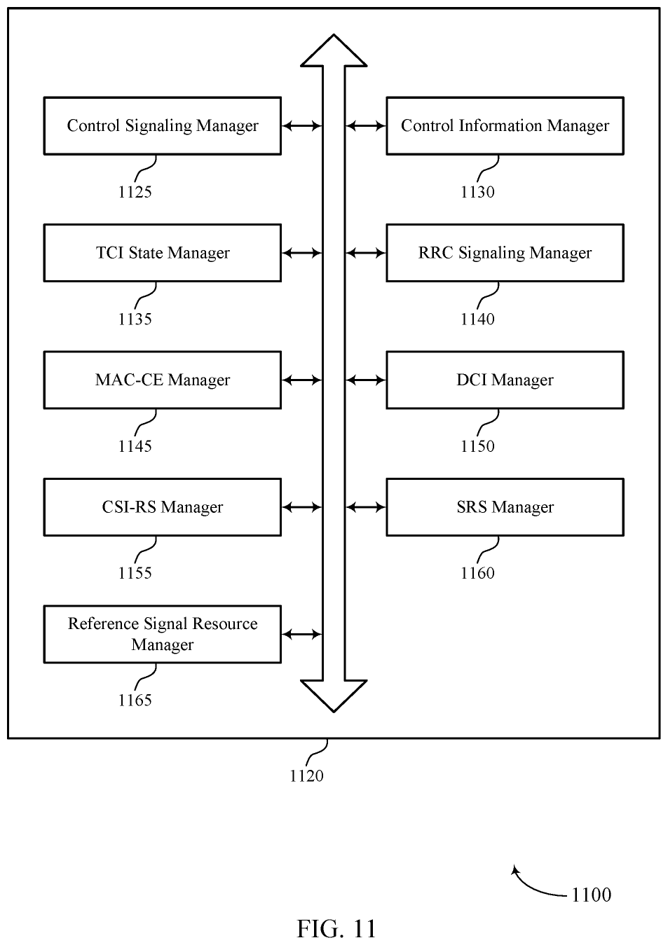

FIG. 11 shows a block diagram 1100 of a communications manager 1120 that supports reference signal communication in the presence of unified transmission configuration indicator states in accordance with aspects of the present disclosure. The communications manager 1120 may be an example of aspects of a communications manager 920, a communications manager 1020, or both, as described herein. The communications manager 1120, or various components thereof, may be an example of means for performing various aspects of reference signal communication in the presence of unified transmission configuration indicator states as described herein. For example, the communications manager 1120 may include a control signaling manager 1125, a control information manager 1130, a TCI state manager 1135, an RRC signaling manager 1140, a MAC-CE manager 1145, a DCI manager 1150, a CSI-RS manager 1155, an SRS manager 1160, a reference signal resource manager 1165, or any combination thereof. Each of these components may communicate, directly or indirectly, with one another (e.g., via one or more buses).

The communications manager 1120 may support wireless communications at a UE in accordance with examples as disclosed herein. The control signaling manager 1125 may be configured as or otherwise support a means for receiving, from a network entity, first control signaling identifying two or more transmission configuration indicator states that are to be applied to communications of one or more channels subsequent to a determined time. In some examples, the control signaling manager 1125 may be configured as or otherwise support a means for receiving, from the network entity, second control signaling including an indication of which transmission configuration indicator state of a pair of transmission configuration indicator states the UE is to apply for communicating reference signals. The control information manager 1130 may be configured as or otherwise support a means for receiving, from the network entity, control information associated with one or more resource allocations for communications after the determined time according to two transmission configuration indicator states of the two or more transmission configuration indicator states, the one or more resource allocations associated with one or more reference signal resources. The TCI state manager 1135 may be configured as or otherwise support a means for communicating according to a first transmission configuration indicator state of the two transmission configuration indicator states via the one or more reference signal resources based on the indication.

In some examples, the two or more transmission configuration indicator states provide for multi-transmission reception point communication with two or more transmission reception points associated with the network entity.

In some examples, to support receiving the second control signaling including the indication, the RRC signaling manager 1140 may be configured as or otherwise support a means for receiving a radio resource control message including the indication, where the indication is associated with a component carrier or a bandwidth part corresponding to the one or more resource allocations.

In some examples, to support receiving the second control signaling including the indication, the RRC signaling manager 1140 may be configured as or otherwise support a means for receiving a radio resource control message including the indication, where the indication is associated with a reference signal resource set or a single reference signal resource.

In some examples, to support receiving the second control signaling including the indication, the MAC-CE manager 1145 may be configured as or otherwise support a means for receiving a MAC-CE including the indication, where the MAC-CE activates the one or more reference signal resources from a set of multiple previously configured reference signal resource sets.

In some examples, to support receiving the second control signaling including the indication, the DCI manager 1150 may be configured as or otherwise support a means for receiving DCI including the indication, the DCI triggering an aperiodic reference signal resource set including the one or more reference signal resources.

In some examples, to support communicating via the one or more reference signal resources, the CSI-RS manager 1155 may be configured as or otherwise support a means for receiving one or more channel state information reference signals via the one or more reference signal resources, where the two transmission configuration indicator states include a pair of downlink transmission configuration indicator states or a pair of joint transmission configuration indicator states.

In some examples, to support communicating via the one or more reference signal resources, the SRS manager 1160 may be configured as or otherwise support a means for transmitting one or more sounding reference signals via the one or more reference signal resources, where the two transmission configuration indicator states include a pair of uplink transmission configuration indicator states or a pair of joint transmission configuration indicator states.

In some examples, to support indication, the TCI state manager 1135 may be configured as or otherwise support a means for an instruction to apply a transmission configuration indicator state of a pair of transmission configuration indicator states that is associated with a lowest index value.

In some examples, the control information is a scheduling DCI that indicates allocated resources for communications, or is an activation DCI that activates communication using previously configured resources.

In some examples, the two or more transmission configuration indicator states are associated with multi-transmission reception point communications with two or more transmission reception points according to a time division multiplexing communications scheme, a frequency division multiplexing communications scheme, a spatial division multiplexing communications scheme, or a single frequency network communications scheme.

In some examples, the one or more channels include a downlink shared channel, uplink shared channel, uplink control channel, or any combinations thereof. In some examples, the control signaling (e.g., the first control signaling) includes one or more of downlink control information having a first format with a transmission configuration indicator state field, or a medium access control (MAC) control element that indicates a single transmission configuration indicator codepoint that is mapped to the two or more transmission configuration indicator states.

Additionally, or alternatively, the communications manager 1120 may support wireless communications at a UE in accordance with examples as disclosed herein. In some examples, the control signaling manager 1125 may be configured as or otherwise support a means for receiving, from a network entity, first control signaling identifying two or more transmission configuration indicator states that are to be applied to communications of one or more channels subsequent to a determined time. In some examples, the control information manager 1130 may be configured as or otherwise support a means for receiving, from the network entity, control information associated with one or more resource allocations for communications after the determined time according to a first transmission configuration indicator state and a second transmission configuration indicator state of the two or more transmission configuration indicator states, the one or more resource allocations associated with a first set of one or more reference signal resources and a second set of one or more reference signal resources. In some examples, the TCI state manager 1135 may be configured as or otherwise support a means for communicating via the first set of one or more reference signal resources according to the first transmission configuration indicator state based on a first identifier associated with the first set of one or more reference signal resources and via the second set of one or more reference signal resources according to the second transmission configuration indicator state based on a second identifier associated with the second set of one or more reference signal resources.

In some examples, the two or more transmission configuration indicator states provide for multi-transmission reception point communications with two or more transmission reception points associated with the network entity.

In some examples, the control signaling manager 1125 may be configured as or otherwise support a means for receiving, from the network entity, second control signaling configuring the first set of one or more reference signal resources and the second set of one or more reference signal resources, where the communicating is based on applying the first transmission configuration indicator state to the first set of one or more reference signal resources and applying the second transmission configuration indicator state to the second set of one or more reference signal resources.

In some examples, the first set of one or more reference signal resources includes a first group of reference signal resources within a reference signal resource set and the second set of one or more reference signal resources includes a second group of reference signal resources within the reference signal resource set. In some examples, the first identifier is associated with the first group of reference signal resources. In some examples, the second identifier is associated with the second group of reference signal resources.

In some examples, the first set of one or more reference signal resources includes a first reference signal resource set and the second set of one or more reference signal resources includes a second reference signal resource set. In some examples, the first identifier is associated with the first reference signal resource set. In some examples, the second identifier is associated with the second reference signal resource set.

In some examples, the RRC signaling manager 1140 may be configured as or otherwise support a means for receiving, from the network entity, a radio resource control message configuring the UE to share a same beam indication, where applying the first transmission configuration indicator state to the first set of one or more reference signal resources and applying the second transmission configuration indicator state to the second set of one or more reference signal resources is based on receiving the radio resource control message.

In some examples, the first set of one or more reference signal resources and the second set of one or more reference signal resources are aperiodic reference signal resources.

In some examples, the communicating is based on a number of reference signal resources in the first set of one or more reference signal resources, the second set of one or more reference signal resources, or both.

In some examples, applying the first transmission configuration indicator state to the first set of one or more reference signal resources and applying the second transmission configuration indicator state to the second set of one or more reference signal resources is based on the first identifier having a lower value than the second identifier.

In some examples, to support receiving the third control signaling configuring the first set of one or more reference signal resources and the second set of one or more reference signal resources, the RRC signaling manager 1140 may be configured as or otherwise support a means for receiving a radio resource control parameter configuring the first set of one or more reference signal resources and the second set of one or more reference signal resources associated with repetition, tracking reference signal (TRS) reception, beam management, antenna switching, codebook-based uplink transmission, non-codebook based uplink transmission, or a combination thereof.

In some examples, to support communicating via the first set of one or more reference signal resources, the CSI-RS manager 1155 may be configured as or otherwise support a means for receiving one or more channel state information reference signals via the first set of one or more reference signal resources and the second set of one or more reference signal resources, where the first transmission configuration indicator state and the second transmission configuration indicator state include a pair of downlink transmission configuration indicator states or a pair of joint transmission indicator states.

In some examples, to support communicating via the first set of one or more reference signal resources, the SRS manager 1160 may be configured as or otherwise support a means for transmitting one or more sounding reference signals via the first set of one or more reference signal resources and the second set of one or more reference signal resources, where the first transmission configuration indicator state and the second transmission configuration indicator state include a pair of uplink transmission configuration indicator states or a pair of joint transmission indicator states.

In some examples, the one or more channels include a downlink shared channel, uplink shared channel, uplink control channel, or any combinations thereof. In some examples, the control signaling (e.g., the first control signaling) includes one or more of downlink control information having a first format with a transmission configuration indicator state field, or a medium access control (MAC) control element that indicates a single transmission configuration indicator codepoint that is mapped to the two or more transmission configuration indicator states.

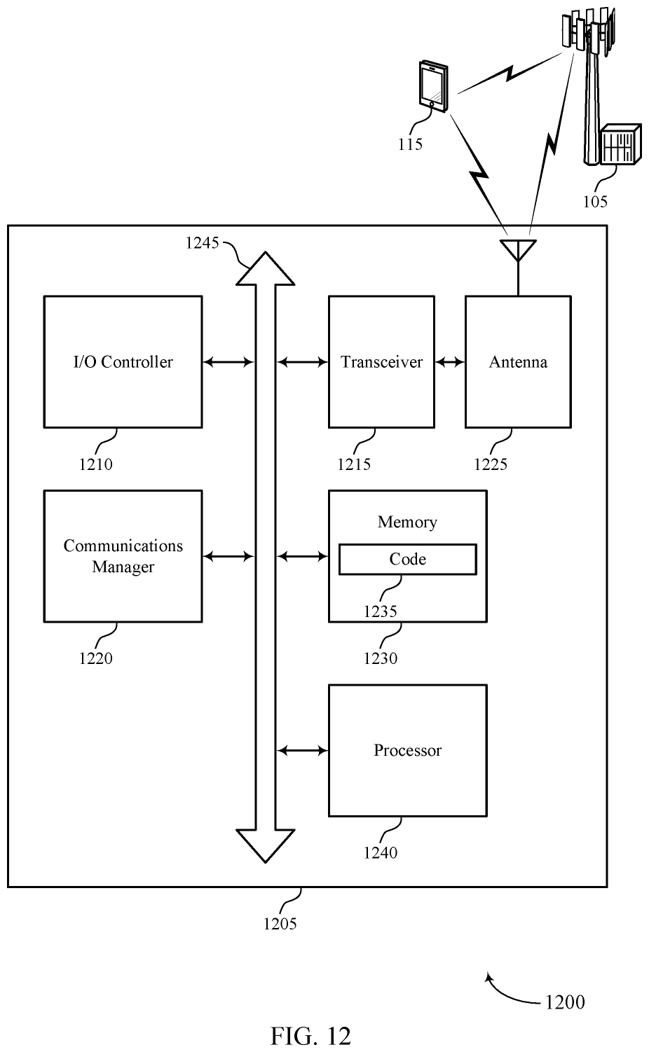

FIG. 12 shows a diagram of a system 1200 including a device 1205 that supports reference signal communication in the presence of unified transmission configuration indicator states in accordance with aspects of the present disclosure. The device 1205 may be an example of or include the components of a device 905, a device 1005, or a UE 115 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOSR, ANDROIDR, MS-DOSR, MS-WINDOWS®, OS/2 (R), UNIX, LINUXR, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting reference signal communication in the presence of unified transmission configuration indicator states). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communications at a UE in accordance with examples as disclosed herein. For example, the communications manager 1220 may be configured as or otherwise support a means for receiving, from a network entity, first control signaling identifying two or more transmission configuration indicator states that are to be applied to communications of one or more channels subsequent to a determined time. The communications manager 1220 may be configured as or otherwise support a means for receiving, from the network entity, second control signaling including an indication of which transmission configuration indicator state of a pair of transmission configuration indicator states the UE is to apply for communicating reference signals. The communications manager 1220 may be configured as or otherwise support a means for receiving, from the network entity, control information associated with one or more resource allocations for communications after the determined time according to two transmission configuration indicator states of the two or more transmission configuration indicator states, the one or more resource allocations associated with one or more reference signal resources. The communications manager 1220 may be configured as or otherwise support a means for communicating according to a first transmission configuration indicator state of the two transmission configuration indicator states via the one or more reference signal resources based on the indication.

Additionally, or alternatively, the communications manager 1220 may support wireless communications at a UE in accordance with examples as disclosed herein. For example, the communications manager 1220 may be configured as or otherwise support a means for receiving, from a network entity, first control signaling identifying two or more transmission configuration indicator states that are to be applied to communications of one or more channels subsequent to a determined time. The communications manager 1220 may be configured as or otherwise support a means for receiving, from the network entity, control information associated with one or more resource allocations for communications after the determined time according to a first transmission configuration indicator state and a second transmission configuration indicator state of the two or more transmission configuration indicator states, the one or more resource allocations associated with a first set of one or more reference signal resources and a second set of one or more reference signal resources. The communications manager 1220 may be configured as or otherwise support a means for communicating via the first set of one or more reference signal resources according to the first transmission configuration indicator state based on a first identifier associated with the first set of one or more reference signal resources and via the second set of one or more reference signal resources according to the second transmission configuration indicator state based on a second identifier associated with the second set of one or more reference signal resources.

By including or configuring the communications manager 1220 in accordance with examples as described herein, the device 1205 may support techniques for applying one of a pair of configured TCI states for communicating reference signals, resulting in improved reference signal communications, improved channel estimation, improved reliability of wireless communications, more efficient use of computational resources, and improved user experience.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of reference signal communication in the presence of unified transmission configuration indicator states as described herein, or the processor 1240 and the memory 1230 may be otherwise configured to perform or support such operations.

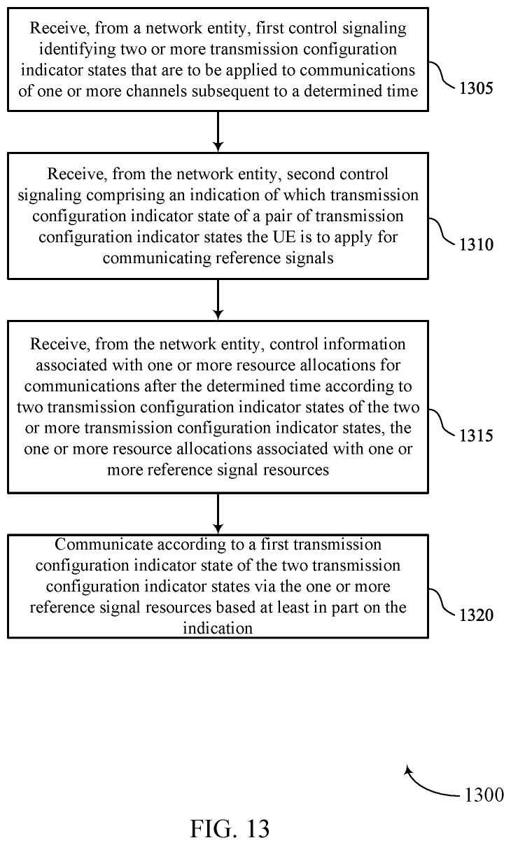

FIG. 13 shows a flowchart illustrating a method 1300 that supports reference signal communication in the presence of unified transmission configuration indicator states in accordance with aspects of the present disclosure. The operations of the method 1300 may be implemented by a UE or its components as described herein. For example, the operations of the method 1300 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1305, the method may include receiving, from a network entity, first control signaling identifying two or more transmission configuration indicator states that are to be applied to communications of one or more channels subsequent to a determined time. The operations of 1305 may be performed in accordance with examples as disclosed herein. In some examples, aspects of the operations of 1305 may be performed by a control signaling manager 1125 as described with reference to FIG. 11.

At 1310, the method may include receiving, from the network entity, second control signaling including an indication of which transmission configuration indicator state of a pair of transmission configuration indicator states the UE is to apply for communicating reference signals. The operations of 1310 may be performed in accordance with examples as disclosed herein. In some examples, aspects of the operations of 1310 may be performed by a control signaling manager 1125 as described with reference to FIG. 11.

At 1315, the method may include receiving, from the network entity, control information associated with one or more resource allocations for communications after the determined time according to two transmission configuration indicator states of the two or more transmission configuration indicator states, the one or more resource allocations associated with one or more reference signal resources. The operations of 1315 may be performed in accordance with examples as disclosed herein. In some examples, aspects of the operations of 1315 may be performed by a control information manager 1130 as described with reference to FIG. 11.

At 1320, the method may include communicating according to a first transmission configuration indicator state of the two transmission configuration indicator states via the one or more reference signal resources based on the indication. The operations of 1320 may be performed in accordance with examples as disclosed herein. In some examples, aspects of the operations of 1320 may be performed by a TCI state manager 1135 as described with reference to FIG. 11.

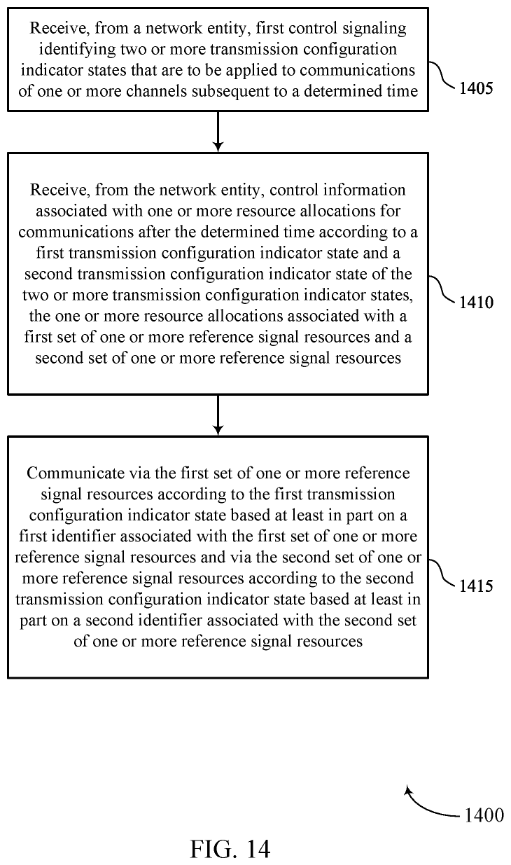

FIG. 14 shows a flowchart illustrating a method 1400 that supports reference signal communication in the presence of unified transmission configuration indicator states in accordance with aspects of the present disclosure. The operations of the method 1400 may be implemented by a UE or its components as described herein. For example, the operations of the method 1400 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, first control signaling identifying two or more transmission configuration indicator states that are to be applied to communications of one or more channels subsequent to a determined time. The operations of 1405 may be performed in accordance with examples as disclosed herein. In some examples, aspects of the operations of 1405 may be performed by a control signaling manager 1125 as described with reference to FIG. 11.

At 1410, the method may include receiving, from the network entity, control information associated with one or more resource allocations for communications after the determined time according to a first transmission configuration indicator state and a second transmission configuration indicator state of the two or more transmission configuration indicator states, the one or more resource allocations associated with a first set of one or more reference signal resources and a second set of one or more reference signal resources. The operations of 1410 may be performed in accordance with examples as disclosed herein. In some examples, aspects of the operations of 1410 may be performed by a control information manager 1130 as described with reference to FIG. 11.

At 1415, the method may include communicating via the first set of one or more reference signal resources according to the first transmission configuration indicator state based on a first identifier associated with the first set of one or more reference signal resources and via the second set of one or more reference signal resources according to the second transmission configuration indicator state based on a second identifier associated with the second set of one or more reference signal resources. The operations of 1415 may be performed in accordance with examples as disclosed herein. In some examples, aspects of the operations of 1415 may be performed by a TCI state manager 1135 as described with reference to FIG. 11.
Aspect 1: A method for wireless communications at a UE, comprising: receiving, from a network entity, first control signaling identifying two or more TCI states that are to be applied to communications of one or more channels subsequent to a determined time: receiving, from the network entity, second control signaling comprising an indication of which TCI state of a pair of TCI states the UE is to apply for communicating reference signals: receiving, from the network entity, control information associated with one or more resource allocations for communications after the determined time according to two TCI states of the two or more TCI states, the one or more resource allocations associated with one or more reference signal resources; and communicating according to a first TCI state of the two TCI states via the one or more reference signal resources based at least in part on the indication.
Aspect 2: The method of aspect 1, wherein the two or more TCI states provide for multi-transmission reception point communication with two or more transmission reception points associated with the network entity.
Aspect 3: The method of any of aspects 1 through 2, wherein receiving the second control signaling comprising the indication comprises: receiving a radio resource control message comprising the indication, wherein the indication is associated with a component carrier or a bandwidth part corresponding to the one or more resource allocations.
Aspect 4: The method of any of aspects 1 through 3, wherein receiving the second control signaling comprising the indication comprises: receiving a radio resource control message comprising the indication, wherein the indication is associated with a reference signal resource set or a single reference signal resource.
Aspect 5: The method of any of aspects 1 through 4, wherein receiving the second control signaling comprising the indication comprises: receiving a media access control control element comprising the indication, wherein the media access control control element activates the one or more reference signal resources from a plurality of previously configured reference signal resource sets.
Aspect 6: The method of any of aspects 1 through 5, wherein receiving the second control signaling comprising the indication comprises: receiving DCI comprising the indication, the DCI triggering an aperiodic reference signal resource set comprising the one or more reference signal resources.
Aspect 7: The method of any of aspects 1 through 6, wherein communicating via the one or more reference signal resources comprises: receiving one or more channel state information reference signals via the one or more reference signal resources, wherein the two TCI states comprise a pair of downlink TCI states or a pair of joint TCI states.
Aspect 8: The method of any of aspects 1 through 7, wherein communicating via the one or more reference signal resources comprises: transmitting one or more sounding reference signals via the one or more reference signal resources, wherein the two TCI states comprise a pair of uplink TCI states or a pair of joint TCI states.
Aspect 9: The method of any of aspects 1 through 8, wherein the indication comprises: an instruction to apply a TCI state of a pair of TCI states that is associated with a lowest index value.
Aspect 10: The method of any of aspects 1 through 9, wherein the control information is a scheduling DCI that indicates allocated resources for communications, or is an activation DCI that activates communication using previously configured resources.
Aspect 11: The method of any of aspects 1 through 10, wherein the two or more TCI states are associated with multi-transmission reception point communications with two or more transmission reception points according to a time division multiplexing communications scheme, a frequency division multiplexing communications scheme, a spatial division multiplexing communications scheme, or a single frequency network communications scheme.
Aspect 12: The method of any of aspects 1 through 11, wherein the one or more channels include a downlink shared channel, uplink shared channel, uplink control channel, or any combinations thereof, and wherein the first control signaling includes one or more of downlink control information having a first format with a TCI state field, or a MAC-CE that indicates a single TCI codepoint that is mapped to the two or more TCI states.
Aspect 13: A method for wireless communications at a UE, comprising: receiving, from a network entity, first control signaling identifying two or more TCI states that are to be applied to communications of one or more channels subsequent to a determined time: receiving, from the network entity, control information associated with one or more resource allocations for communications after the determined time according to a first TCI state and a second TCI state of the two or more TCI states, the one or more resource allocations associated with a first set of one or more reference signal resources and a second set of one or more reference signal resources; and communicating via the first set of one or more reference signal resources according to the first TCI state based at least in part on a first identifier associated with the first set of one or more reference signal resources and via the second set of one or more reference signal resources according to the second TCI state based at least in part on a second identifier associated with the second set of one or more reference signal resources.
Aspect 14: The method of aspect 13, wherein the two or more TCI states provide for multi-transmission reception point communications with two or more transmission reception points associated with the network entity.
Aspect 15: The method of any of aspects 13 through 14, further comprising: receiving, from the network entity, second control signaling configuring the first set of one or more reference signal resources and the second set of one or more reference signal resources, wherein the communicating is based at least in part on applying the first TCI state to the first set of one or more reference signal resources and applying the second TCI state to the second set of one or more reference signal resources.
Aspect 16: The method of aspect 15, wherein the first set of one or more reference signal resources comprises a first group of reference signal resources within a reference signal resource set and the second set of one or more reference signal resources comprises a second group of reference signal resources within the reference signal resource set: the first identifier is associated with the first group of reference signal resources; and the second identifier is associated with the second group of reference signal resources.
Aspect 17: The method of any of aspects 15 through 16, wherein the first set of one or more reference signal resources comprises a first reference signal resource set and the second set of one or more reference signal resources comprises a second reference signal resource set; the first identifier is associated with the first reference signal resource set; and the second identifier is associated with the second reference signal resource set.
Aspect 18: The method of any of aspects 15 through 17, further comprising: receiving, from the network entity, a radio resource control message configuring the UE to share a same beam indication, wherein applying the first TCI state to the first set of one or more reference signal resources and applying the second TCI state to the second set of one or more reference signal resources is based at least in part on receiving the radio resource control message.
Aspect 19: The method of any of aspects 15 through 18, wherein the first set of one or more reference signal resources and the second set of one or more reference signal resources are aperiodic reference signal resources.
Aspect 20: The method of any of aspects 15 through 19, wherein the communicating is based at least in part on a number of reference signal resources in the first set of one or more reference signal resources, the second set of one or more reference signal resources, or both.
Aspect 21: The method of any of aspects 15 through 20, wherein applying the first TCI state to the first set of one or more reference signal resources and applying the second TCI state to the second set of one or more reference signal resources is based at least in part on the first identifier having a lower value than the second identifier.
Aspect 22: The method of any of aspects 15 through 21, wherein receiving the second signaling configuring the first set of one or more reference signal resources and the second set of one or more reference signal resources comprises: receiving a radio resource control parameter configuring the first set of one or more reference signal resources and the second set of one or more reference signal resources associated with repetition, tracking reference signal (TRS) reception, beam management, antenna switching, codebook-based uplink transmission, non-codebook based uplink transmission, or a combination thereof.
Aspect 23: The method of any of aspects 15 through 22, wherein communicating via the first set of one or more reference signal resources comprises: receiving one or more channel state information reference signals via the first set of one or more reference signal resources and the second set of one or more reference signal resources, wherein the first TCI state and the second TCI state comprise a pair of downlink TCI states or a pair of joint transmission indicator states.
Aspect 24: The method of any of aspects 15 through 23, wherein communicating via the first set of one or more reference signal resources comprises: transmitting one or more sounding reference signals via the first set of one or more reference signal resources and the second set of one or more reference signal resources, wherein the first TCI state and the second TCI state comprise a pair of uplink TCI states or a pair of joint transmission indicator states.
Aspect 25: The method of any of aspects 15 through 24, wherein the one or more channels include a downlink shared channel, uplink shared channel, uplink control channel, or any combinations thereof, and wherein the first control signaling includes one or more of downlink control information having a first format with a TCI state field, or a MAC-CE that indicates a single TCI codepoint that is mapped to the two or more TCI states.
Aspect 26: An apparatus for wireless communications at a UE, comprising a processor; memory coupled with the processor; and instructions stored in the memory and executable by the processor to cause the apparatus to perform a method of any of aspects 1 through 12.
Aspect 27: An apparatus for wireless communications at a UE, comprising at least one means for performing a method of any of aspects 1 through 12.
Aspect 28: A non-transitory computer-readable medium storing code for wireless communications at a UE, the code comprising instructions executable by a processor to perform a method of any of aspects 1 through 12.
Aspect 29: An apparatus for wireless communications at a UE, comprising a processor: memory coupled with the processor; and instructions stored in the memory and executable by the processor to cause the apparatus to perform a method of any of aspects 13 through 25.
Aspect 30: An apparatus for wireless communications at a UE, comprising at least one means for performing a method of any of aspects 13 through 25.
Aspect 31: A non-transitory computer-readable medium storing code for wireless communications at a UE, the code comprising instructions executable by a processor to perform a method of any of aspects 13 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving, from a network entity, first control signaling identifying two or more transmission configuration indicator states that are to be applied to communications of one or more channels subsequent to a determined time:
receiving, from the network entity, second control signaling comprising an indication of which transmission configuration indicator state of a pair of transmission configuration indicator states the UE is to apply for communicating reference signals:
receiving, from the network entity, control information associated with one or more resource allocations for communications after the determined time according to two transmission configuration indicator states of the two or more transmission configuration indicator states, the one or more resource allocations associated with one or more reference signal resources; and
communicating according to a first transmission configuration indicator state of the two transmission configuration indicator states via the one or more reference signal resources based at least in part on the indication.

2. The method of claim 1, wherein the two or more transmission configuration indicator states provide for multi-transmission reception point communication with two or more transmission reception points associated with the network entity.

3. The method of claim 1, wherein receiving the second control signaling comprising the indication comprises:
receiving a radio resource control message comprising the indication, wherein the indication is associated with a component carrier or a bandwidth part corresponding to the one or more resource allocations.

4. The method of claim 1, wherein receiving the second control signaling comprising the indication comprises:
receiving a radio resource control message comprising the indication, wherein the indication is associated with a reference signal resource set or a single reference signal resource.

5. The method of claim 1, wherein receiving the second control signaling comprising the indication comprises:
receiving a media access control control element comprising the indication, wherein the media access control control element activates the one or more reference signal resources from a plurality of previously configured reference signal resource sets.

6. The method of claim 1, wherein receiving the second control signaling comprising the indication comprises:
receiving downlink control information (DCI) comprising the indication, the DCI triggering an aperiodic reference signal resource set comprising the one or more reference signal resources.

7. The method of claim 1, wherein communicating via the one or more reference signal resources comprises:
receiving one or more channel state information reference signals via the one or more reference signal resources, wherein the two transmission configuration indicator states comprise a pair of downlink transmission configuration indicator states or a pair of joint transmission configuration indicator states.

8. The method of claim 1, wherein communicating via the one or more reference signal resources comprises:
transmitting one or more sounding reference signals via the one or more reference signal resources, wherein the two transmission configuration indicator states comprise a pair of uplink transmission configuration indicator states or a pair of joint transmission configuration indicator states.

9. The method of claim 1, wherein the indication comprises:
an instruction to apply a transmission configuration indicator state of a pair of transmission configuration indicator states that is associated with a lowest index value.

10. The method of claim 1, wherein the control information is a scheduling downlink control information (DCI) that indicates allocated resources for communications, or is an activation DCI that activates communication using previously configured resources.

11. The method of claim 1, wherein the two or more transmission configuration indicator states are associated with multi-transmission reception point communications with two or more transmission reception points according to a time division multiplexing communications scheme, a frequency division multiplexing communications scheme, a spatial division multiplexing communications scheme, or a single frequency network communications scheme.

12. The method of claim 1, wherein:
the one or more channels include a downlink shared channel, uplink shared channel, uplink control channel, or any combinations thereof, and wherein
the first control signaling includes one or more of downlink control information having a first format with a transmission configuration indicator state field, or a medium access control (MAC) control element that indicates a single transmission configuration indicator codepoint that is mapped to the two or more transmission configuration indicator states.

13. A method for wireless communications at a user equipment (UE), comprising:
receiving, from a network entity, first control signaling identifying two or more transmission configuration indicator states that are to be applied to communications of one or more channels subsequent to a determined time:
receiving, from the network entity, control information associated with one or more resource allocations for communications after the determined time according to a first transmission configuration indicator state and a second transmission configuration indicator state of the two or more transmission configuration indicator states, the one or more resource allocations associated with a first set of one or more reference signal resources and a second set of one or more reference signal resources: and
communicating via the first set of one or more reference signal resources according to the first transmission configuration indicator state based at least in part on a first identifier associated with the first set of one or more reference signal resources and via the second set of one or more reference signal resources according to the second transmission configuration indicator state based at least in part on a second identifier associated with the second set of one or more reference signal resources.

14. The method of claim 13, wherein the two or more transmission configuration indicator states provide for multi-transmission reception point communications with two or more transmission reception points associated with the network entity.

15. The method of claim 13, further comprising:
receiving, from the network entity, second control signaling configuring the first set of one or more reference signal resources and the second set of one or more reference signal resources, wherein the communicating is based at least in part on applying the first transmission configuration indicator state to the first set of one or more reference signal resources and applying the second transmission configuration indicator state to the second set of one or more reference signal resources.

16. The method of claim 15, wherein:
the first set of one or more reference signal resources comprises a first group of reference signal resources within a reference signal resource set and the second set of one or more reference signal resources comprises a second group of reference signal resources within the reference signal resource set:
the first identifier is associated with the first group of reference signal resources; and
the second identifier is associated with the second group of reference signal resources.

17. The method of claim 15, wherein:
the first set of one or more reference signal resources comprises a first reference signal resource set and the second set of one or more reference signal resources comprises a second reference signal resource set:
the first identifier is associated with the first reference signal resource set; and
the second identifier is associated with the second reference signal resource set.

18. The method of claim 15, further comprising:
receiving, from the network entity, a radio resource control message configuring the UE to share a same beam indication, wherein applying the first transmission configuration indicator state to the first set of one or more reference signal resources and applying the second transmission configuration indicator state to the second set of one or more reference signal resources is based at least in part on receiving the radio resource control message.

19. The method of claim 15, wherein the first set of one or more reference signal resources and the second set of one or more reference signal resources are aperiodic reference signal resources.

20. The method of claim 15, wherein the communicating is based at least in part on a number of reference signal resources in the first set of one or more reference signal resources, the second set of one or more reference signal resources, or both.

21. The method of claim 15, wherein applying the first transmission configuration indicator state to the first set of one or more reference signal resources and applying the second transmission configuration indicator state to the second set of one or more reference signal resources is based at least in part on the first identifier having a lower value than the second identifier.

22. The method of claim 15, wherein receiving the second signaling configuring the first set of one or more reference signal resources and the second set of one or more reference signal resources comprises:
receiving a radio resource control parameter configuring the first set of one or more reference signal resources and the second set of one or more reference signal resources associated with repetition, tracking reference signal (TRS) reception, beam management, antenna switching, codebook-based uplink transmission, non-codebook based uplink transmission, or a combination thereof.

23. The method of claim 15, wherein communicating via the first set of one or more reference signal resources comprises:
receiving one or more channel state information reference signals via the first set of one or more reference signal resources and the second set of one or more reference signal resources, wherein the first transmission configuration indicator state and the second transmission configuration indicator state comprise a pair of downlink transmission configuration indicator states or a pair of joint transmission indicator states.

24. The method of claim 15, wherein communicating via the first set of one or more reference signal resources comprises:
transmitting one or more sounding reference signals via the first set of one or more reference signal resources and the second set of one or more reference signal resources, wherein the first transmission configuration indicator state and the second transmission configuration indicator state comprise a pair of uplink transmission configuration indicator states or a pair of joint transmission indicator states.

25. The method of claim 15, wherein:
the one or more channels include a downlink shared channel, uplink shared channel, uplink control channel, or any combinations thereof, and wherein
the first control signaling includes one or more of downlink control information having a first format with a transmission configuration indicator state field, or a medium access control (MAC) control element that indicates a single transmission configuration indicator codepoint that is mapped to the two or more transmission configuration indicator states.

26. An apparatus for wireless communications at a user equipment (UE), comprising:
a processor:
memory coupled with the processor; and
instructions stored in the memory and executable by the processor to cause the UE to:
receive, from a network entity, first control signaling identifying two or more transmission configuration indicator states that are to be applied to communications of one or more channels subsequent to a determined time;
receive, from the network entity, second control signaling comprising an indication of which transmission configuration indicator state of a pair of transmission configuration indicator states the UE is to apply for communicating reference signals:
receive, from the network entity, control information associated with one or more resource allocations for communications after the determined time according to two transmission configuration indicator states of the two or more transmission configuration indicator states, the one or more resource allocations associated with one or more reference signal resources; and
communicate according to a first transmission configuration indicator state of the two transmission configuration indicator states via the one or more reference signal resources based at least in part on the indication.

27. The apparatus of claim 26, wherein the instructions to communicate via the one or more reference signal resources are executable by the processor to cause the UE to:
receive one or more channel state information reference signals via the one or more reference signal resources, wherein the two transmission configuration indicator states comprise a pair of downlink transmission configuration indicator states or a pair of joint transmission configuration indicator states.

28. The apparatus of claim 26, wherein the instructions to communicate via the one or more reference signal resources are executable by the processor to cause the UE to:
transmit one or more sounding reference signals via the one or more reference signal resources, wherein the two transmission configuration indicator states comprise a pair of uplink transmission configuration indicator states or a pair of joint transmission configuration indicator states.

29. The apparatus of claim 26, wherein the instructions to indication are executable by the processor to cause the UE to:
an instruction to apply a transmission configuration indicator state of a pair of transmission configuration indicator states that is associated with a lowest index value.

30. An apparatus for wireless communications at a user equipment (UE), comprising:
a processor:
memory coupled with the processor; and
instructions stored in the memory and executable by the processor to cause the UE to:
receive, from a network entity, first control signaling identifying two or more transmission configuration indicator states that are to be applied to communications of one or more channels subsequent to a determined time:
receive, from the network entity, control information associated with one or more resource allocations for communications after the determined time according to a first transmission configuration indicator state and a second transmission configuration indicator state of the two or more transmission configuration indicator states, the one or more resource allocations associated with a first set of one or more reference signal resources and a second set of one or more reference signal resources; and
communicate via the first set of one or more reference signal resources according to the first transmission configuration indicator state based at least in part on a first identifier associated with the first set of one or more reference signal resources and via the second set of one or more reference signal resources according to the second transmission configuration indicator state based at least in part on a second identifier associated with the second set of one or more reference signal resources.
